(19) United States
(12) Patent Application Publication
(10) Pub. No.: US 2022/0275231 A1
(43) Pub. Date: Sep. 1, 2022

(54) Aqueous Ink Jet Ink Composition, Ink Jet Recording Method, and Ink Jet Recording Apparatus

(71) Applicant: Seiko Epson Corporation, Tokyo (JP)

(72) Inventors: Tomoki MARUYAMA, Matsumoto (JP); Tetsuya AOYAMA, Shiojiri (JP); Masahiro YATAKE, Shiojiri (JP); Satoshi TSUBAMOTO, Shiojiri (JP)

(21) Appl. No.: 17/680,384

(22) Filed: Feb. 25, 2022

(30) Foreign Application Priority Data
Feb. 26, 2021 (JP) 2021-030130

(51) Int. Cl. C09D 11/322; C09D 11/033; C08K 5/3415; C08K 5/053; B41J 2/175

(52) U.S. Cl. CPC C09D 11/322; C09D 11/033; C08K 5/3415; C08K 5/053; B41J 2/17503

(57) ABSTRACT

An aqueous ink jet ink composition contains a color material, water, a polyhydric alcohol having a standard boiling point of 270.0° C. or more, and 1-(2-hydroxyethyl)-2-pyrrolidone. The mass ratio of the content of the polyhydric alcohol to that of 1-(2-hydroxyethyl)-2-pyrrolidone is 3.1 or more and 7.0 or less.

The present application is based on, and claims priority from JP Application Serial Number 2021-030130, filed Feb. 26, 2021, the disclosure of which is hereby incorporated by reference herein in its entirety.

### BACKGROUND

### 1. Technical Field

The present disclosure relates to an aqueous ink jet ink composition, an ink jet recording method, and an ink jet recording apparatus.

### 2. Related Art

An ink jet method can form high-quality images on recording media, and various technological developments have been carried out. Development of recording apparatuses using the ink jet method is also active. Furthermore, the requirements for the performance of the aqueous ink jet ink composition that is used in the apparatus are also widespread.

For example, it has been studied to use an organic solvent as a solvent or a dispersion medium in an aqueous ink jet ink composition. In also an aqueous ink jet ink composition, selection of an organic solvent and the blending amount thereof are broadly investigated in order to obtain desired performance. For example, JP-A-2002-371207 describes that 3-quinuclidinol is used as an organic solvent for dissolving or dispersing a color material and that hydroxyethyl pyrrolidone is used in combination.

In development of an aqueous ink jet ink composition, if some performances are improved, other performances may deteriorate. Accordingly, in development of an aqueous ink jet ink composition, it is also required to improve multiple performances with good balance among many required performances. For example, in the ink disclosed in JP-A-2002-371207, although some performances, such as image sharpness, are improved, other performances may be insufficient, for example, curling is generated by adhesion of the ink to a recording medium.

### SUMMARY

An aspect of the aqueous ink jet ink composition according to the present disclosure is

an aqueous ink jet ink composition containing a color material, water, a polyhydric alcohol having a standard boiling point of 270.0° C. or more, and 1-(2-hydroxyethyl)-2-pyrrolidone, wherein

the mass ratio of the content of the polyhydric alcohol to that of the 1-(2-hydroxyethyl)-2-pyrrolidone is 3.1 or more and 7.0 or less.

An aspect of the ink jet recording method according to the present disclosure includes:

discharging the above-described aqueous ink jet ink composition from a recording head to adhere the composition to a recording medium.

An aspect of the ink jet recording apparatus according to the present disclosure includes:

the above-described aqueous ink jet ink composition;

an ink container for accommodating the aqueous ink jet ink composition; and

a recording head for discharging the aqueous ink jet ink composition, wherein

the ink container has an openable and closable ink inlet for loading the aqueous ink jet ink composition.

### BRIEF DESCRIPTION OF THE DRAWINGS

FIG. 1 is a perspective oblique view schematically illustrating the schematic configuration of a first embodiment of the recording apparatus.

FIG. 2 is an oblique view illustrating an ink supply unit provided in the housing of a recording apparatus.

FIG. 3 is a plan view of the ink supply unit.

FIG. 4 is a partially broken cross-sectional view taken along the line IV-IV in FIG. 3.

FIG. 5 is a partially broken cross-sectional view taken along the line V-V in FIG. 3.

FIG. 6 is an oblique view of an ink container with the cap removed.

FIG. 7 is a side view of the ink container.

FIG. 8 is a front view of the ink container.

FIG. 9 is a plan view of the ink container.

FIG. 10 is a cross-sectional view taken along the line X-X in FIG. 9.

FIG. 11 is a cross-sectional view taken along the line XI-XI in FIG. 9.

FIG. 12 is a partially broken front view illustrating the state immediately before the ink refilling work for an ink tank.

FIG. 13 is a partially broken side view illustrating the state immediately before the ink refilling work for the ink tank.

FIG. 14 is a partially broken front view illustrating the state during the ink refilling work for the ink tank.

FIG. 15 is a partially broken side view illustrating the state during the ink refilling work for the ink tank.

FIG. 16 is a partially broken front view illustrating the state in which a positioning portion of the ink container is in contact with a receiving surface on the ink tank side during ink refilling.

FIG. 17 is a partially broken side view illustrating the state in which the positioning portion of the ink container is in contact with the receiving surface on the ink tank side during ink refilling.

### DESCRIPTION OF EXEMPLARY EMBODIMENTS

Embodiments of the present disclosure will now be described. The embodiments described below describe examples of the present disclosure. The present disclosure is not limited to the following embodiments and includes various modifications that are implemented within a range not changing the gist of the present disclosure. It should be noted that not all of the configurations described below are essential configurations of the present disclosure.

In the present specification, the term “(meth)acrylic” represents acrylic or methacrylic, and the term “(meth)acrylate” refers to acrylate or methacrylate.

### 1. Aqueous Ink Jet Ink Composition

The aqueous ink jet ink composition of the present embodiment contains a color material, water, a polyhydric alcohol having a standard boiling point of 270.0° C. or more, and 1-(2-hydroxyethyl)-2-pyrrolidone.

### 1.1. Color Material

The aqueous ink jet ink composition includes a color material. Examples of the color material include a water-soluble dye, a disperse dye, and a pigment, and any of these materials may be used, or a mixture thereof may be used. However, the aqueous ink jet ink composition may include a pigment, and when only a pigment is contained, a more remarkable effect is expressed.

### 1.1.1. Water-Soluble Dye

The aqueous ink jet ink composition of the present embodiment may include one or more water-soluble dyes selected from acid dyes, reactive dyes, and direct dyes. Furthermore, the dyes may be used alone or in combination of two or more.

Examples of the acid dye include:

C.I. Acid Red 1, 6, 8, 9, 13, 14, 18, 19, 24, 26, 27, 28, 32, 35, 37, 42, 51, 52, 57, 62, 75, 77, 80, 82, 83, 85, 87, 88, 89, 92, 94, 95, 97, 106, 111, 114, 115, 117, 118, 119, 127, 128, 129, 130, 131, 133, 134, 138, 143, 145, 149, 151, 154, 155, 158, 168, 180, 183, 184, 186, 194, 198, 199, 209, 211, 215, 216, 217, 219, 249, 252, 254, 256, 257, 260, 261, 262, 263, 265, 266, 274, 276, 282, 283, 289, 299, 301, 303, 305, 315, 318, 320, 321, 322, 336, 337, 361, 396, and 397;

### C.I. Acid Violet 5, 7, 11, 15, 31, 34, 35, 41, 43, 47, 48, 49, 51, 54, 66, 68, 75, 78, 90, 97, 103, 106, and 126;

C.I. Acid Yellow 1, 3, 7, 11, 17, 19, 23, 25, 29, 36, 38, 39, 40, 42, 44, 49, 50, 59, 61, 64, 70, 72, 75, 76, 78, 79, 98, 99, 110, 111, 112, 114, 116, 118, 119, 127, 128, 131, 135, 141, 142, 143, 151, 159, 161, 162, 163, 164, 165, 169, 174, 184, 190, 195, 196, 197, 199, 207, 218, 219, 222, 227, and 246;
C.I. Acid Blue 1, 7, 9, 15, 22, 23, 25, 27, 29, 40, 41, 43, 45, 49, 54, 59, 60, 62, 72, 74, 76, 78, 80, 82, 83, 87, 90, 92, 93, 100, 102, 103, 104, 106, 112, 113, 114, 117, 120, 126, 127, 127:1, 128, 129, 130, 131, 133, 138, 140, 142, 143, 151, 154, 156, 158, 161, 166, 167, 168, 170, 171, 175, 181, 182, 183, 184, 185, 187, 192, 193, 201, 203, 204, 205, 207, 209, 220, 221, 224, 225, 229, 230, 232, 239, 247, 249, 258, 260, 264, 271, 277, 277:1, 278, 279, 280, 284, 288, 290, 296, 298, 300, 317, 324, 326, 333, 335, 338, 342, and 350;

### C.I. Acid Black 1, 2, 7, 24, 26, 29, 31, 44, 48, 50, 51, 52, 52:1, 58, 60, 62, 63, 64, 67, 72, 76, 77, 94, 107, 108, 109, 110, 112, 115, 118, 119, 121, 122, 131, 132, 139, 140, 155, 156, 157, 158, 159, 172, 191, 194, and 234;

### C.I. Acid Orange 1, 7, 8, 10, 19, 20, 24, 28, 33, 41, 43, 45, 51, 56, 63, 64, 65, 67, 74, 80, 82, 85, 86, 87, 88, 94, 95, 122, 123, and 124;

### C.I. Acid Green 3, 7, 9, 12, 16, 19, 20, 25, 27, 28, 35, 36, 40, 41, 43, 44, 48, 56, 57, 60, 61, 65, 73, 75, 76, 78, and 79;

### C.I. Acid Brown 2, 4, 13, 14, 19, 20, 27, 28, 30, 31, 39, 44, 45, 46, 48, 53, 100, 101, 103, 104, 106, 160, 161, 165, 188, 224, 225, 226, 231, 232, 236, 247, 256, 257, 266, 268, 276, 277, 282, 289, 294, 295, 296, 297, 298, 299, 300, 301, and 302.

Examples of the direct dye include:

### C.I. Direct Red 2, 4, 9, 23, 26, 31, 39, 62, 63, 72, 75, 76, 79, 80, 81, 83, 84, 89, 92, 95, 111, 173, 184, 207, 211, 212, 214, 218, 221, 223, 224, 225, 226, 227, 232, 233, 240, 241, 242, 243, and 247;

### C.I. Direct Violet 7, 9, 47, 48, 51, 66, 90, 93, 94, 95, 98, 100, and 101;

### C.I. Direct Yellow 8, 9, 11, 12, 27, 28, 29, 33, 35, 39, 41, 44, 50, 53, 58, 59, 68, 86, 87, 93, 95, 96, 98, 100, 106, 108, 109, 110, 130, 132, 142, 144, 161, and 163;

C.I. Direct Blue 1, 10, 15, 22, 25, 41, 55, 67, 68, 71, 76, 77, 78, 80, 84, 86, 87, 90, 98, 106, 108, 109, 120, 151, 156, 158, 159, 160, 153, 168, 189, 192, 193, 194, 199, 200, 201, 202, 203, 207, 211, 213, 214, 218, 225, 226, 229, 236, 237, 244, 248, 249, 251, 252, 264, 270, 280, 288, 289, and 291; and

### C.I. Direct Black 9, 17, 19, 22, 32, 51, 56, 62, 69, 77, 80, 91, 94, 97, 108, 112, 113, 114, 117, 118, 121, 122, 125, 132, 146, 154, 166, 168, 173, 195, and 199.

Examples of the reactive dye include:

### C.I. Reactive Yellow 1, 2, 3, 5, 11, 13, 14, 15, 17, 18, 20, 21, 22, 23, 24, 25, 26, 27, 29, 35, 37, 40, 41, 42, 47, 51, 55, 65, 67, 81, 95, 116, 142, and 161;

### C.I. Reactive Red 1, 3, 3:1, 4, 13, 14, 17, 19, 21, 22, 23, 24, 24:1, 25, 26, 29, 31, 32, 35, 37, 40, 41, 43, 44, 45, 46, 49, 55, 60, 66, 74, 79, 96, 97, 108, 141, 180, 218, 226, and 245;

### C.I. Reactive Violet 1, 3, 4, 5, 6, 7, 8, 9, 16, 17, 22, 23, 24, 26, 27, 33, and 34;

### C.I. Reactive Blue 1, 2, 3, 5, 7, 8, 10, 13, 14, 15, 17, 18, 19, 21, 23, 25, 26, 27, 28, 29, 32, 35, 38, 41, 49, 63, 72, 75, 80, 95, and 190;

### C.I. Reactive Orange 1, 2, 4, 5, 7, 12, 13, 14, 16, 20, 29, 33, 35, 38, 64, 67, 71, 72, 72:1, 78, 82, 84, 86, 87, 91, 99, 99:1, 107, 113, 122, 124, and 125; and

### C.I. Reactive Black 1, 3, 4, 5, 7, 8, 11, 12, 14, 17, 21, 23, 26, 31, 32, 34, and 39.

The content of the water-soluble dye based on the total mass of the aqueous ink jet ink composition is about 0.1 mass % or more and 30 mass % or less in total and may be 0.5 mass % or more and 25 mass % or less, 1 mass % or more and 20 mass % or less, or 5 mass % or more and 15 mass % or less.

In the aqueous ink jet ink composition of the present embodiment, when the water-soluble dye is at least one selected from acid dyes, reactive dyes, and direct dyes, recording media can be deeply dyed by using this composition in printing of the recording media.

### 1.1.2. Disperse Color Material

The aqueous ink jet ink composition may use a disperse color material as the color material. The disperse color material is a color material that is insoluble in solvents and is, for example, a pigment or a disperse dye. The pigment and disperse dye that are insoluble or difficult to dissolve in solvents are not particularly limited, and examples thereof include inorganic pigments, organic pigments, oil-soluble dyes, and disperse dyes. In addition, the hues of the pigment and the dye are not limited and may be so-called process color, such as cyan, magenta, yellow, or black, or so-called spot color, such as white, fluorescent, or glitter color.

As the inorganic pigment, for example, carbon black (C.I. Pigment Black 7) pigments, such as furnace black, lamp black, acetylene black, and channel black, iron oxide, titanium oxide, zinc oxide, and silica can be used.

Examples of the carbon black include No. 2300, 900, MCF88, No. 20B, No. 33, No. 40, No. 45, No. 52, MA7, MA8, MA100, and No2200B manufactured by Mitsubishi Chemical Corporation. In addition, examples of the carbon black include Color Black series FW1, FW2, FW2V, FW18, FW200, 5150, S160, and 5170, Pretex series 35, U, V, and 140U, and Spetial Black series 6, 5, 4A, 4, and 250 manufactured by Degussa Huls AG. Furthermore, examples of the carbon black include Conductex SC and Raven series 1255, 5750, 5250, 5000, 3500, 1255, and 700 manufactured by Columbia Carbon. In addition, examples of the carbon black include REGAL series 400R, 330R, and 660R, MOGUL L, MONARCH series 700, 800, 880, 900, 1000, 1100, 1300, and 1400, and ELFTEX 12 manufactured by Cabot Corporation. Furthermore, examples of the carbon black include BONJET BLACK series CW-1, CW-1S, CW-2, CW-3, and M-800 manufactured by Orient Chemical Industries Co., Ltd.

Examples of the organic pigment include a quinacridone pigment, a quinacridone quinone pigment, a dioxazine pigment, a phthalocyanine pigment, an anthrapyrimidine pigment, an anthanthrone pigment, an indanthrone pigment, a flavanthron pigment, a perylene pigment, a diketopyrrolopyrrole pigment, a perinone pigment, a kinophthalone pigment, an anthraquinone pigment, a thioindigo pigment, a benzimidazolone pigment, an isoindolinone pigment, an azomethine pigment, and an azo pigment.

Examples of the cyan pigment include C.I. Pigment Blue 1, 2, 3, 15:3, 15:4, 15:34, 16, 22, and 60 and C.I. Vat Blue 4 and 60; and the cyan pigment may be, for example, one or a mixture of two or more selected from the group consisting of C.I. Pigment Blue 15:3, 15:4, and 60.

Examples of the magenta pigment include C.I. Pigment Red 5, 7, 12, 48(Ca), 48(Mn), 57(Ca), 57:1, 112, 122, 123, 168, 184, and 202 and C.I. Pigment Violet 19, and the magenta pigment may be, for example, one or a mixture of two or more selected from the group consisting of C.I. Pigment Red 122, 202, and 209 and C.I. Pigment Violet 19.

Examples of the yellow pigment include C.I. Pigment Yellow 1, 2, 3, 12, 13, 14C, 16, 17, 73, 74, 75, 83, 93, 95, 97, 98, 119, 110, 114, 128, 129, 138, 150, 151, 154, 155, 180, and 185, and the yellow pigment may be, for example, one or a mixture of two or more selected from the group consisting of C.I. Pigment Yellow 74, 109, 110, 128, and 138.

Examples of the orange pigment include C.I. Pigment Orange 36 and 43 and mixtures thereof. Examples of the pigment that is used in a green ink jet recording aqueous ink include C.I. Pigment Green 7 and 36 and mixtures thereof.

The glitter pigment is not particularly limited as long as the pigment can glitter when attached to a medium, and examples thereof include metal particles of an alloy (also referred to as metal pigment) of one or more selected from the group consisting of aluminum, silver, gold, platinum, nickel, chromium, tin, zinc, indium, titanium, and copper; and a pearl pigment having pearl luster. Typical examples of the pearl pigment include pigments having pearl luster or interference luster, such as titanium dioxide-coated mica, fish scale flakes, and bismuth acid chloride. In addition, the glitter pigment may be surface-treated for suppressing the reaction with water.

In addition, examples of the white pigment include metal compounds, such as a metal oxide, barium sulfate, and calcium carbonate. Examples of the metal oxide include titanium dioxide, zinc oxide, silica, alumina, and magnesium oxide. In addition, as the white pigment, particles having a hollow structure may be used.

The pigment may be used by being previously dispersed using a dispersant. Examples of the dispersant include (meth)acrylic resins and salts thereof, such as poly(meth)acrylic acid, a (meth)acrylic acid-acrylonitrile copolymer, a (meth)acrylic acid-(meth)acrylic acid ester copolymer, a vinyl acetate-(meth)acrylic acid ester copolymer, a vinyl acetate-(meth)acrylic acid copolymer, and a vinylnaphthalene-(meth)acrylic acid copolymer; styrene resins and salts thereof, such as a styrene-(meth)acrylic acid copolymer, a styrene-(meth)acrylic acid-(meth)acrylic acid ester copolymer, a styrene-α-methylstyrene-(meth)acrylic acid copolymer, a styrene-α-methylstyrene-(meth)acrylic acid-(meth)acrylic acid ester copolymer, a styrene-maleic acid copolymer, and a styrene-maleic anhydride copolymer; and polymer compounds (resins) having a urethane bond formed by a reaction between an isocyanate group and a hydroxyl group. These dispersants may be in a straight chain form and/or a branched chain form, and examples thereof include water-soluble resins, such as a urethane resin with or without a crosslinked structure and salts thereof; polyvinyl alcohols; a vinylnaphthalene-maleic acid copolymer and salts thereof; a vinyl acetate-maleic acid ester copolymer and salts thereof; and a vinyl acetate-crotonic acid copolymer and salts thereof.

As commercial products of the dispersant for a styrene-acrylic resin, for example, X-200, X-1, X-205, X-220, and X-228 (manufactured by Seiko PMC Corporation), Nopcosperse (registered trademark) series 6100 and 6110 (manufactured by San Nopco Limited), Joncryl series 67, 586, 611, 678, 680, 682, and 819 (manufactured by BASF SE), DISPERBYK-190 (manufactured by BYK Chemie Japan K.K.), and N-EA137, N-EA157, N-EA167, N-EA177, N-EA197D, N-EA207D, and E-EN10 (manufactured by DKS Co., Ltd.) are mentioned.

Examples of commercial product of the acrylic resin dispersant include BYK-187, BYK-190, BYK-191, BYK-194N, and BYK-199 (manufactured by BYK-Chemie GmbH), and Aron series A-210, A6114, AS-1100, AS-1800, A-30SL, A-7250, and CL-2 (manufactured by Toagosei Co., Ltd.).

Examples of commercial product of the urethane resin dispersant include BYK-182, BYK-183, BYK-184, and BYK-185 (manufactured by BYK-Chemie GmbH), TEGO Dispers 710 (manufactured by Evonic Tego Chemie GmbH), and Borchi (registered trademark) Gen1350 (manufactured by OMG Borchers GmbH).

The dispersants may be used alone or in combination of two or more. The total content of the dispersants may be 0.1 parts by mass or more and 30 parts by mass or less based on 50 parts by mass of the pigment and may be 0.5 parts by mass or more and 25 parts by mass or less, 1 part by mass or more and 20 parts by mass or less, or 1.5 parts by mass or more and 15 parts by mass or less. When the content of the dispersants is 0.1 parts by mass or more based on 50 parts by mass of the pigment, the dispersion stability of the pigment can be further enhanced. In addition, when the content of the dispersants is 30 parts by mass or less based on 50 parts by mass of the pigment, the viscosity of the resulting dispersion can be kept smaller.

In addition, as the disperse dye or the oil-soluble dye, any color material that is dispersed in an ink vehicle without being dissolved therein can be used, and examples thereof include azo, metal complex salt azo, anthraquinone, phthalocyanine, and triarylmethane dyes.

Examples of the disperse dye include C.I. Disperse Red 60, 82, 86, 86:1, 92, 152, 154, 167:1, 191, and 279; C.I. Disperse Yellow 64, 71, 86, 114, 153, 163, 233, and 245; C.I. Disperse Blue 27, 60, 73, 77, 77:1, 87, 165, 165:1, 257, and 367; C.I. Disperse Violet 26, 33, 36, and 57; and C.I. Disperse Orange 30, 41, 61, and 80.

The disperse color material may be those that can be stably dispersed in inks. For example, the disperse color material may be used as a self-dispersible color material by oxidizing the color material surface with ozone, hypochlorous acid, fuming sulfuric acid, or the like or by modifying the color material particle surface through sulfonation or may be used by being dispersed by a known dispersant.

The pigments and the disperse dyes exemplified as the disperse color material are merely examples, and these pigments and disperse dyes may be used alone or in combination of two or more, and a combination of a pigment and a disperse dye or a combination of a water-soluble dye and a disperse color material can also be used.

When a pigment among the above-mentioned color materials is used in the aqueous ink jet ink composition, the effect of maintaining good dispersion stability by the solvent composition becomes more remarkable.

### 1.2. Water

The aqueous ink jet ink composition according to the present embodiment contains water. Examples of the water include water with low ionic impurities, for example, pure water, such as ion-exchanged water, ultrafiltered water, reverse osmosis water, and distilled water, and ultrapure water. In addition, the use of water sterilized by, for example, UV irradiation or addition of hydrogen peroxide can suppress the outbreak of bacteria or fungi when the aqueous ink jet ink composition is stored for a long time.

The content of water can be 30 mass % or more based on the total mass of the aqueous ink jet ink composition and may be 40 mass % or more, 45 mass % or more, or 50 mass % or more. The term “water in the aqueous ink jet ink composition” includes, for example, the water contained in raw materials and the water to be added. When the content of water is 30 mass % or more, the aqueous ink jet ink composition can have a relatively low viscosity. In addition, the upper limit of the content of water can be 90 mass % or less based on the total mass of the aqueous ink jet ink composition and may be 85 mass % or less or 80 mass % or less.

### 1.3. Polyhydric Alcohol Having Standard Boiling Point of 270.0° C. or More

The polyhydric alcohol having a standard boiling point of 270.0° C. or more contained in the aqueous ink jet ink composition of the present embodiment is an organic compound including two or more hydroxy groups bonded to carbon and having a standard boiling point of 270.0° C. or more. The standard boiling point refers to the boiling point at 1 atm.

Examples of the polyhydric alcohol having a standard boiling point of 270.0° C. or more include, but not limited to, glycerol, triethylene glycol, tetraethylene glycol, triethanolamine, and tripropanolamine.

The polyhydric alcohol having a standard boiling point of 270.0° C. or more has an effect of suppressing evaporation of water in the aqueous ink jet ink composition. Even when the content of the polyhydric alcohol is small, for example, 0.0001 mass % or 0.001 mass % based on the total amount of the composition, it is possible to impart a moisture retaining property to the aqueous ink jet ink composition. However, from the viewpoint of making the moisture retaining property very excellent, the content of the polyhydric alcohol having a standard boiling point of 270.0° C. or more in the aqueous ink jet ink composition may be 1.0 mass % or more.

The content of the polyhydric alcohol having a standard boiling point of 270.0° C. or more can be 2.0 mass % or more and 40.0 mass % or less based on the total mass of the aqueous ink jet ink composition and may be 5.0 mass % or more and 20.0 mass % or less or 5.0 mass % or more and 13.0 mass % or less. When the content of the polyhydric alcohol having a standard boiling point of 270.0° C. or more is within the above-mentioned range, an effect of suppressing the curling of a recording medium is further obtained. In particular, when the content is 20.0 mass % or less, the dispersion stability of the color material in the aqueous ink jet ink composition can be further enhanced.

In addition, the standard boiling point of the polyhydric alcohol having a standard boiling point of 270.0° C. or more may be less than 304° C. When such a polyhydric alcohol having a standard boiling point of 270.0° C. or more is selected, 1-(2-hydroxyethyl)-2-pyrrolidone described below is likely to remain in the solvent contained in the aqueous ink jet ink composition until the end of drying, and the recombination of hydrogen bonds is likely to be delayed. Accordingly, curling of the recording medium can be further suppressed.

1.4. 1-(2-Hydroxyethyl)-2-pyrrolidone

The aqueous ink jet ink composition according to the present embodiment includes 1-(2-hydroxyethyl)-2-pyrrolidone. 1-(2-Hydroxyethyl)-2-pyrrolidone is called by another name, such as N-hydroxyethylpyrrolidone or 1-(2-hydroxyethyl)pyrrolidin-2-one (in the present specification, may be abbreviated to “HEP”).

HEP has a relatively high standard boiling point (304° C.) compared to solvents having the same molecular weight due in part to the fact that it includes a hydroxy group. Since HEP has a high standard boiling point, the volatilization rate of the solvent after adhesion of the aqueous ink jet ink composition to a surface of a recording medium is reduced, and the surface of the recording medium is likely to maintain the state of wetting with the solvent. Consequently, curling of a recording medium including cellulose can be particularly suppressed. In addition, since HEP has a pyrrolidone skeleton and having a relatively bulky three-dimensional structure, when hydrogen bonds are reconstructed, it is possible to form looser hydrogen bonds or delay the formation of the bonds, compared to when other solvents, such as a polyhydric alcohol and water, are dried on a recording medium. Consequently, HEP can also contribute to suppression of contraction by drying of, particularly, a recording medium containing cellulose.

The solubility of the water-soluble dye in the ink jet ink composition can be enhanced by containing HEP in the composition, and precipitation and solidification of the water-soluble dye can be prevented from occurring. When the precipitation and the solidification of the water-soluble dye are unlikely to occur, the aqueous ink jet ink composition can have excellent discharge stability and clogging recovery. In addition, this effect is particularly significant when the concentration of the water-soluble dye in the aqueous ink jet ink composition is high.

The content of HEP can be 0.5 mass % or more and 30.0 mass % or less based on the total mass of the aqueous ink jet ink composition and may be 1.0 mass % or more and 20.0 mass % or less or 2.0 mass % or more and 10.0 mass % or less.

### 1.5. Content Ratio of Polyhydric Alcohol Having Standard Boiling Point of 270.0° C. or More and HEP

In the aqueous ink jet ink composition of the present embodiment, the mass ratio of the content of the polyhydric alcohol having a standard boiling point of 270.0° C. or more to that of 1-(2-hydroxyethyl)-2-pyrrolidone is 3.1 or more and 7.0 or less.

When the ratio of the content of the polyhydric alcohol having a standard boiling point of 270.0° C. or more to that of HEP is 3.1 or more and 7.0 or less, the clogging recovery of the aqueous ink jet ink composition in recording heads is improved, and curling of recording media after adhesion of the aqueous ink jet ink composition to the recording media can be reduced.

From the viewpoint of reducing curling and further enhancing line marker resistance, the content of the polyhydric alcohol having a standard boiling point of 270.0° C. or more relative to that of HEP may be 3.3 or more and 6.5 or less or 3.3 or more and 4.5 or less.

### 1.6. Other Component

The aqueous ink jet ink composition of the present embodiment may contain an organic solvent other than the above, water, a chelating agent, and other materials.

### 1.6.1. Other Organic Solvent

The aqueous ink jet ink composition of the present embodiment may contain an organic solvent other than the above-described polyhydric alcohol having a standard boiling point of 270.0° C. or more and HEP. Examples of the organic solvent include an alkyl polyol, a glycol ether, and a cyclic amide.

### 1.6.1.1. Alkyl Polyol

The aqueous ink jet ink composition of the present embodiment may include an alkyl polyol. The concept of the alkyl polyol includes polyhydric alcohols, but the alkyl polyol described in this section has a standard boiling point of less than 270.0° C. When an alkyl polyol is included in the aqueous ink jet ink composition, the moisture loss through the recording head during leaving for a long time can be effectively suppressed while enhancing the moisture retaining property of the aqueous ink jet ink composition and making the discharge stability in an ink jet method excellent. In addition, consequently, even if the color material used is a type that is prone to cause nozzle clogging, the recovery after being left and continuous discharge stability can be maintained better.

Examples of the alkyl polyol include 1,2-butanediol, 1,2-pentanediol, 1,2-hexanediol, 1,2-heptanediol, 1,3-propanediol, 1,3-butanediol, 1,4-butanediol, 1,5-pentanediol, 1,6-hexanediol, 2-ethyl-2-methyl-1,3-propanediol, 2-methyl-2-propyl-1,3-propanediol, 2-methyl-1,3-propanediol, 2,2-dimethyl-1,3-propanediol, 3-methyl-1,3-butanediol, 2-ethyl-1,3-hexanediol, 3-methyl-1,5-pentanediol, 2-methylpentane-2,4-diol, diethylene glycol, propylene glycol, and dipropylene glycol. These alkyl polyols may be used alone or in combination of two or more.

The aqueous ink jet ink composition may include, among the alkyl polyols, an alkanediol having 3 to 6 carbon atoms. Examples of the alkanediol having 3 to 6 carbon atoms include 1,2-butanediol, 1,2-pentanediol, 1,2-hexanediol, 1,2-heptanediol, 1,3-propanediol, 1,3-butanediol, 1,4-butanediol, 1,5-pentanediol, 1,6-hexanediol, 2-ethyl-2-methyl-1,3-propanediol, 2-methyl-1,3-propanediol, 2,2-dimethyl-1,3-propanediol, 3-methyl-1,3-butanediol, 3-methyl-1,5-pentanediol, and 2-methylpentane-2,4-diol.

In the aqueous ink jet ink composition including an alkanediol having 3 to 6 carbon atoms, the viscosity is further reduced, and better discharge stability (continuous discharge reliability) can be obtained. In addition, the solubility or dispersibility of the color material is likely to be good, and good clogging recovery can be obtained.

### 1.6.1.2. Glycol Ether

The aqueous ink jet ink composition of the present embodiment may include a glycol ether. The glycol ether is, for example, a monoalkyl ether or dialkyl ether of glycol selected from ethylene glycol, diethylene glycol, triethylene glycol, polyethylene glycol, propylene glycol, dipropylene glycol, tripropylene glycol, polypropylene glycol, and polyoxyethylene polyoxypropylene glycol. More specifically, examples of the glycol ether include methyl triglycol (triethylene glycol monomethyl ether), butyl triglycol (triethylene glycol monobutyl ether), butyl diglycol (diethylene glycol monobutyl ether), and dipropylene glycol monopropyl ether. A typical example is diethylene glycol monobutyl ether.

The aqueous ink jet ink composition may further contain, among the glycol ethers, one or more selected from glycol ethers represented by the following formula (1):

R¹—O—(CH₂—CH₂—O)ₙ—R² (1)

(in the formula (1), R¹ represents H or an alkyl group having 1 to 4 carbon atoms, R² represents an alkyl group having 1 to 4 carbon atoms, and n represents an integer of 2 or 3).

Examples of the glycol ether represented by the formula (1) include methyl triglycol (triethylene glycol monomethyl ether), butyl triglycol (triethylene glycol monobutyl ether), butyl diglycol (diethylene glycol monobutyl ether), triethylene glycol dimethyl ether, triethylene glycol dibutyl ether, and diethylene glycol dibutyl ether.

A mixture of a plurality of glycol ethers may be used. In addition, when the glycol ether is used, the amount thereof is 0.5 mass % or more and 30 mass % or less based on the total mass of the aqueous ink jet ink composition from the viewpoint of adjusting the viscosity of the aqueous ink jet ink composition and suppressing clogging by the moisturizing effect and may be 1.0 mass % or more and 20 mass % or less or 3.0 mass % or more and 10.0 mass % or less.

### 1.6.1.3. Cyclic Amide

The aqueous ink jet ink composition of the present embodiment may include a cyclic amide. However, since the cyclic amide is similar to the above-described HEP in the chemical structure, the cyclic amide can be used to the extent that does not interfere the effect of HEP. The cyclic amide has functions of easily dissolving the above-described dyes and suppressing solidification and drying of the aqueous ink jet ink composition.

As the cyclic amide, a compound having a ring structure including an amide group is mentioned. Examples of such a compound include γ-lactams, such as 2-pyrrolidone, 1-methyl-2-pyrrolidone (N-methyl-2-pyrrolidone), 1-ethyl-2-pyrrolidone (N-ethyl-2-pyrrolidone), 1-propyl-2-pyrrolidone, 1-butyl-2-pyrrolidone, and N-vinyl-2-pyrrolidone (NVP), β-lactams, δ-lactams, and ε-lactams, such as ε-caprolactam. These cyclic amides may be used alone or in combination of two or more.

### 1.6.1.4. Other Organic Solvent

The aqueous ink jet ink composition of the present embodiment may include an additional organic solvent. Examples of the additional organic solvent include lactones, such as γ-butyrolactone, and betaine compounds.

### 1.6.2. Other Materials

The aqueous ink jet ink composition of the present embodiment may contain a surfactant, a resin particle, a pH adjuster, a chelating agent, a urea, a preservative, a fungicide, a corrosion inhibitor, a saccharide, and other additives, as materials other than the above-mentioned materials.

### 1.6.2.1. Surfactant

The aqueous ink jet ink composition according to the present embodiment may include a surfactant. The surfactant can be used for reducing the surface tension of the aqueous ink jet ink composition to adjust or improve the wettability to a recording medium, for example, permeability to a fabric or the like. As the surfactant, any of nonionic surfactants, anionic surfactants, cationic surfactants, and amphoteric surfactants can be used, and further a combination thereof may be used. In particular, among these surfactants, an acetylene glycol surfactant, a silicone surfactant, or a fluorine surfactant may be used.

The acetylene glycol surfactant is not particularly limited, and examples thereof include Surfynol series 104, 104E, 104H, 104A, 104BC, 104DPM, 104PA, 104PG-50, 104S, 420, 440, 465, 485, SE, SE-F, 504, 61, DF37, CT111, CT121, CT131, CT136, TG, GA, and DF110D (trade names, manufactured by Air Products and Chemicals, Inc.), Olfine series B, Y, P, A, STG, SPC, E1004, E1010, PD-001, PD-002W, PD-003, PD-004, PD-005, EXP.4001, EXP.4036, EXP.4051, EXP.4123, EXP.4300, AF-103, AF-104, AK-02, SK-14, and AE-3 (trade names, manufactured by Nissin Chemical Co., Ltd.), and Acetylenol series E00, E00P, E40, and E100 (trade names, manufactured by Kawaken Fine Chemicals Co., Ltd.).

Although the silicone surfactant is not particularly limited, a polysiloxane compound may be used. The polysiloxane compound is not particularly limited, and, for example, polyether modified organosiloxane is mentioned. Examples of commercial product of the polyether modified organosiloxane include BYK-306, BYK-307, BYK-333, BYK-341, BYK-345, BYK-346, and BYK-348 (trade names, manufactured by BYK) and KF-351A, KF-352A, KF-353, KF-354L, KF-355A, KF-615A, KF-945, KF-640, KF-642, KF-643, KF-6020, X-22-4515, KF-6011, KF-6012, KF-6015, and KF-6017 (trade names, manufactured by Shin-Etsu Chemical Co., Ltd.).

As the fluorine surfactant, a fluorine modified polymer may be used, and examples thereof include BYK-340 (trade name, manufactured by BYK Chemie Japan K.K.).

When surfactants are blended in the aqueous ink jet ink composition, the total amount of the surfactants can be 0.01 mass % or more and 3 mass % or less based on the total amount of the aqueous ink jet ink composition and may be 0.05 mass % or more and 2 mass % or less, 0.1 mass % or more and 1.5 mass % or less, or 0.2 mass % or more and 1 mass % or less.

In addition, the aqueous ink jet ink composition containing a surfactant tends to increase the stability when the ink is discharged from a head.

### 1.6.2.2. Resin Particle

The aqueous ink jet ink composition may contain a resin particle. The resin particle can further improve, for example, the adhesion of the image by the aqueous ink jet ink composition adhered to a recording medium. Examples of the resin particle include resin particles made of a urethane resin, an acrylic resin (including a styrene acrylic resin), a fluorene resin, a polyolefin resin, a rosin modified resin, a terpene resin, a polyester resin, a polyamide resin, an epoxy resin, a vinyl chloride resin, a vinyl chloride-vinyl acetate copolymer, or an ethylene vinyl acetate resin. In particular, a urethane resin, an acrylic resin, a polyolefin resin, or a polyester resin may be used. These resin particles are often handled in emulsion form, but the resin particles may have properties of powder. The resin particles to be used may be one type of particle or a combination of two or more types of particles.

The urethane resin is a generic name of resins having a urethane bond. As the urethane resin, for example, a polyether urethane resin having an ether bond in the main chain in addition to the urethane bond, a polyester urethane resin having an ester bond in the main chain in addition to the urethane bond, or a polycarbonate urethane resin having a carbonate bond in the main chain in addition to the urethane bond may be used. In addition, as the urethane resin, commercial products may be used. For example, SUPERFLEX series 460, 460s, 840, and E-4000 (trade names, manufactured by DKS Co., Ltd.), RESAMINE series D-1060, D-2020, D-4080, D-4200, D-6300, and D-6455 (trade names, manufactured by Dainichiseika Color & Chemicals Mfg. Co., Ltd.), Takelac series WS-5100, WS-6021, and W-512-A-6 (trade names, manufactured by Mitsui Chemicals Polyurethanes, Inc.), Sancure 2710 (trade name, manufactured by The Lubrizol Corporation), and PERMARIN UA-150 (trade name, manufactured by Sanyo Chemical Industries, Ltd.) may be used.

The acrylic resin is a generic name of polymers obtained by polymerizing at least an acrylic monomer, such as (meth)acrylic acid or (meth)acrylic acid ester, as one component, and examples thereof include a resin obtained from an acrylic monomer and a copolymer of an acrylic monomer and another monomer. For example, an acrylic-vinyl resin, which is a copolymer of an acrylic monomer and a vinyl monomer, is mentioned. In addition, for example, styrene is mentioned as the vinyl monomer.

As the acrylic monomer, for example, acryl amide and acrylonitrile can also be used. The resin emulsion using an acrylic resin as a raw material may be a commercial product and may be selected from, for example, FK-854 (trade name, manufactured by Chuo Rika Kogyo Corporation), Movinyl series 952B and 718A (trade names, manufactured by The Nippon Synthetic Chemical Industry Co., Ltd.), and Nipol series LX852 and LX874 (trade names, manufactured by Zeon Corporation).

Incidentally, in the present specification, the acrylic resin may be a styrene-acrylic resin described below. In addition, in the present specification, the notation “(meth)acrylic” means at least one of acrylic and methacrylic.

The styrene-acrylic resin is a copolymer prepared from a styrene monomer and a (meth)acrylic monomer, and examples thereof include a styrene-acrylic acid copolymer, a styrene-methacrylic acid copolymer, a styrene-methacrylic acid-acrylic acid ester copolymer, a styrene-α-methylstyrene-acrylic acid copolymer, and a styrene-α-methylstyrene-acrylic acid-acrylic acid ester copolymer. As the styrene-acrylic resin, commercial products may be used. For example, Joncryl series 62J, 7100, 390, 711, 511, 7001, 632, 741, 450, 840, 74J, HRC-1645J, 734, 852, 7600, 775, 537J, 1535, PDX-7630A, 352J, 352D, PDX-7145, 538J, 7640, 7641, 631, 790, 780, and 7610 (trade names, manufactured by BASF SE), Movinyl series 966A and 975N (trade names, manufactured by The Nippon Synthetic Chemical Industry Co., Ltd.), and Vinylblan 2586 (trade name, manufactured by Nissin Chemical Co., Ltd.) may be used.

The polyolefin resin has olefin, such as ethylene, propylene, or butylene, in the structure skeleton, and an appropriately selected known polyolefin resin can be used. As the olefin resin, commercial products can be used, and for example, Arrowbase series CB-1200 and CD-1200 (trade names, manufactured by Unitika Ltd.) may be used.

In addition, the resin particles may be supplied in an emulsion form, and examples of commercial product of such resin emulsion include Microgel series E-1002 and E-5002 (trade names, manufactured by Nippon Paint Co., Ltd., styrene-acrylic resin emulsion), VONCOAT 4001 (trade name, manufactured by DIC Corporation, acrylic resin emulsion), VONCOAT 5454 (trade name, manufactured by DIC Corporation, styrene-acrylic resin emulsion), Polysol series AM-710, AM-920, AM-2300, AP-4735, AT-860, and PSASE-4210E (acrylic resin emulsion), Polysol AP-7020 (styrene-acrylic resin emulsion), Polysol SH-502 (vinyl acetate resin emulsion), Polysol series AD-13, AD-2, AD-10, AD-96, AD-17, and AD-70 (ethylene-vinyl acetate resin emulsion), Polysol PSASE-6010 (ethylene-vinyl acetate resin emulsion) (trade names, manufactured by Showa Denko K.K.), SAE1014 (trade name, styrene-acrylic resin emulsion, manufactured by Zeon Corporation), SAIVINOL SK-200 (trade name, acrylic resin emulsion, manufactured by Saiden Chemical Industry Co., Ltd.), AE-120A (trade name, manufactured by JSR Corporation, acrylic resin emulsion), AE373D (trade name, manufactured by Emulsion Technology Co., Ltd., carboxy modified styrene-acrylic resin emulsion), SEIKADYNE 1900W (trade name, manufactured by Dainichiseika Color & Chemicals Mfg. Co., Ltd., ethylene-vinyl acetate resin emulsion), VINYBLAN 2682 (acrylic resin emulsion), VINYBLAN 2886 (vinyl acetate-acrylic resin emulsion), and VINYBLAN 5202 (acetic acid acrylic resin emulsion) (trade names, manufactured by Nissin Chemical Co., Ltd.), Elitel series KA-5071S, KT-8803, KT-9204, KT-8701, KT-8904, and KT-0507 (trade names, manufactured by Unitika Ltd., polyester resin emulsion), Hitech SN-2002 (trade name, manufactured by TOHO Chemical Industry Co., Ltd., polyester resin emulsion), Takelac series W-6020, W-635, W-6061, W-605, W-635, and W-6021 (trade names, manufactured by Mitsui Chemicals Polyurethanes, Inc., urethane resin emulsion), SUPERFLEX series 870, 800, 150, 420, 460, 470, 610, and 700 (trade names, manufactured by DKS Co., Ltd., urethane resin emulsion), PERMARIN UA-150 (manufactured by Sanyo Chemical Industries, Ltd., urethane resin emulsion), Sancure 2710 (manufactured by The Lubrizol Corporation, urethane resin emulsion), NeoRez series R-9660, R-9637, and R-940 (manufactured by Kusumoto Chemicals, Ltd., urethane resin emulsion), ADEKA BONTIGHTER series HUX-380 and 290K (manufactured by ADEKA Corporation, urethane resin emulsion), Movinyl 966A and Movinyl 7320 (manufactured by The Nippon Synthetic Chemical Industry Co., Ltd.), Joncryl series 7100, 390, 711, 511, 7001, 632, 741, 450, 840, 74J, HRC-1645J, 734, 852, 7600, 775, 537J, 1535, PDX-7630A, 352J, 352D, PDX-7145, 538J, 7640, 7641, 631, 790, 780, and 7610 (manufactured by BASF SE), NK Binder R-5HN (manufactured by Shin-Nakamura Chemical Co., Ltd.), HYDRAN WLS-210 (non-crosslinkable polyurethane: manufactured by DIC Corporation), and Joncryl 7610 (manufactured by BASF SE).

The content of the resin particles contained in the aqueous ink jet ink composition is 0.1 mass % or more and 20 mass % or less as the solid content based on the total mass of the aqueous ink jet ink composition and may be 1 mass % or more and 15 mass % or less or 2 mass % or more and 10 mass % or less.

### 1.6.2.3. Chelating Agent

The aqueous ink jet ink composition of the present embodiment may use a chelating agent. The chelating agent can remove a certain ion in the aqueous ink jet ink composition.

Examples of the chelating agent include ethylenediaminetetraacetic acid and salts thereof, such as EDTA, EDTA-2Na (disodium dihydrogen ethylenediaminetetraacetate), EDTA-3Na (tris odium hydrogen ethylenediaminetetraacetate), EDTA-4Na (tetrasodium ethylenediaminetetraacetate), and EDTA-3K (tripotassium hydrogen ethylenediaminetetraacetate); diethylenetriaminepentaacetic acid and salts thereof, such as DTPA, DTPA-2Na (disodium diethylenetriaminepentaacetate) and DTPA-5Na (pentasodium diethylenetriaminepentaacetate); nitrilotriacetic acid and salts thereof, such as NTA, NTA-2Na (disodium nitrilotriacetate) and NTA-3Na (trisodium nitrilotriacetate); ethylenediamine-N,N′-disuccinic acid and salts thereof; 3-hydroxy-2,2′-iminodisuccinic acid and salts thereof; L-aspartic-N,N′-diacetic acid and salts thereof; L-glutamic diacetic acid and salts thereof; N-(1-carboxylatomethyl)iminodiacetic acid and salts thereof; and N-(2-hydroxyethyl)iminodiacetic acid and salts thereof.

In addition, examples of the chelating agent other than acetic acid analogues include ethylenediaminetetramethylenephosphonic acid and salts thereof, ethylenediaminetetrametaphosphoric acid and salts thereof, ethylenediaminepyrophosphoric acid and salts thereof, and ethylenediaminemetaphosphoric acid and salts thereof.

When the aqueous ink jet ink composition of the present embodiment contains a chelating agent, one or more selected from the above-mentioned chelating agents can be used.

### 1.6.2.4. pH Adjuster

The aqueous ink jet ink composition of the present embodiment can contain a pH adjuster. The pH adjuster is not particularly limited, and examples thereof include an appropriate combination of an acid, a base, a weak acid, and a weak base. Examples of the acid and the base to be used in the combination include inorganic acids, such as sulfuric acid, hydrochloric acid, and nitric acid; inorganic bases, such as lithium hydroxide, sodium hydroxide, potassium hydroxide, potassium dihydrogen phosphate, disodium hydrogen phosphate, potassium carbonate, sodium carbonate, sodium hydrogen carbonate, and ammonia; organic bases, such as diethanolamine, monoethanolamine, triisopropanolamine, diisopropanolamine, and tris(hydroxymethyl)aminomethane (THAM); and organic acids, such as adipic acid, citric acid, succinic acid, and lactic acid. Good's buffers, such as N,N-bis(2-hydroxyethyl)-2-aminoethanesulfonic acid (BES), 4-(2-hydroxyethyl)-1-piperazineethanesulfonic acid (HEPES), morpholinoethanesulfonic acid (MES), morpholinopropanesulfonic acid (MOPS), carbamoylmethyliminobisacetic acid (ADA), piperazine-1,4-bis(2-ethanesulfonic acid) (PIPES), N-(2-acetamide)-2-aminoethanesulfonic acid (ACES), cholamine chloride, N-tris(hydroxymethyl)methyl-2-aminoethanesulfonic acid (TES), acetamide glycine, tricine, glycinamide, and bicine; and phosphate buffer, citrate buffer, Tris buffer, etc. may be used. Furthermore, among these pH adjusters, when a tertiary amine, such as triethanolamine and triisopropanolamine, and a carboxyl group-containing organic acid, such as adipic acid, citric acid, succinic acid, and lactic acid, are contained as a part or the whole of the pH adjuster, a pH buffering effect can be more stably obtained.

### 1.6.2.5. Ureas

As a moisturizing agent of the aqueous ink jet ink composition or as a dyeing assistant for improving the dyeing property of a dye, a urea may be used. Examples of the urea include urea, ethyleneurea, tetramethylurea, thiourea, and 1,3-dimethyl-2-imidazolidinone. When a urea is contained, the content thereof can be 1 mass % or more and 10 mass % or less based on the total mass of the aqueous ink jet ink composition.

### 1.6.2.6. Preservative, Fungicide, and Corrosion Inhibitor

The aqueous ink jet ink composition may use a preservative or a fungicide. Examples of the preservative and fungicide include sodium benzoate, sodium pentachlorophenol, sodium 2-pyridinethiol-1-oxide, sodium sorbate, sodium dehydroacetate, 1,2-dibenzisothiazolin-3-one (PROXEL CRL, PROXEL BDN, PROXEL GXL, PROXEL XL-2, PROXEL TN, and PROXEL LV of ZENECA Inc.), and 4-chloro-3-methylphenol (e.g., PREVENTOL CMK of Bayer AG). Examples of the corrosion inhibitor include benzotriazole.

### 1.6.2.7. Saccharides

In order to suppress the solidification and drying of the aqueous ink jet ink composition, a saccharide may be used. Examples of the saccharide include glucose, mannose, fructose, ribose, xylose, arabinose, galactose, aldonic acid, glucitol (sorbitol), maltose, cellobiose, lactose, sucrose, trehalose, and maltotriose.

### 1.6.2.8. Others

Furthermore, as components other than the above-mentioned components, the aqueous ink jet ink composition may contain additives that can be usually used in aqueous ink jet ink compositions for ink jet, such as an antioxidant, an UV absorber, an oxygen absorber, and a dissolving assistant.

### 1.7. Manufacturing and Physical Properties of Aqueous Ink Jet Ink Composition

The aqueous ink jet ink composition can be obtained by mixing the above-mentioned components in an arbitrary order and removing impurities through, for example, filtration as needed. As the method for the mixing, a method of sequentially adding materials to a container equipped with a stirring device, such as a mechanical stirrer or a magnetic stirrer, and stirring and mixing the materials may be employed. As the method for filtration, for example, centrifugal filtration or filter filtration can be performed as needed.

The aqueous ink jet ink composition may have a surface tension of 20 mN/m or more and 40 mN/m or less at 20° C. from the viewpoint of reliability as an ink jet ink and may have a surface tension of 22 mN/m or more and 35 mN/m or less. In addition, from the same viewpoint, the viscosity of the ink at 20° C. may be 1.5 mPa·s or more and 10 mPa·s or less or 2 mPa·s or more and 8 mPa·s or less. As one approach for adjusting the surface tension and the viscosity within the above-mentioned ranges, for example, the types of the above-described organic solvent and surfactant and the amounts of these components and water are adjusted.

### 1.8. Effects and so on

In the aqueous ink jet ink composition, the volatilization rate is suppressed after adhesion to the surface of a recording medium by the influence of the high standard boiling point (304° C.) of 1-(2-hydroxyethyl)-2-pyrrolidone, and the surface of the recording medium is likely to maintain the wet state with the solvent. Consequently, curling of a recording medium including cellulose can be particularly suppressed. In addition, since 1-(2-hydroxyethyl)-2-pyrrolidone has a bulky three-dimensional structure, it is possible to form looser hydrogen bonds or delay the formation of the bonds when hydrogen bonds are reconstructed with progress of drying, compared to when other solvents, such as a polyhydric alcohol having a standard boiling point of 270.0° C. or more and water, are dried. Consequently, 1-(2-hydroxyethyl)-2-pyrrolidone can contribute to also suppression of contraction of, particularly, a recording medium containing cellulose by drying.

In addition, the polyhydric alcohol having a standard boiling point of 270.0° C. or more has a plurality of hydroxy groups and can thereby enhance the moisture absorbing and retaining properties of the aqueous ink jet ink composition. Accordingly, the polyhydric alcohol can suppress the sudden volatilization of a solvent, such as water, from the recording medium and also in this point, works effectively for suppressing curling of the recording medium.

### 2. Ink Jet Recording Apparatus

The aqueous ink jet ink composition of the present embodiment may be used by being loaded in an ink jet recording apparatus that includes an openable and closable ink inlet and an ink storage unit for storing the injected ink. A risk of moisture loss from the inlet portion is caused by using the composition in such an ink jet recording apparatus, but good dispersion stability of the color material can be maintained. That is, since the aqueous ink jet ink composition contains 1-(2-hydroxyethyl)-2-pyrrolidone, the dispersion stability of the color material is better against evaporation of moisture. This effect is remarkable particularly when the standard boiling point (304° C.) of 1-(2-hydroxyethyl)-2-pyrrolidone is higher than the standard boiling point of the polyhydric alcohol having a standard boiling point of 270.0° C. or more.

An example of the ink jet recording apparatus including an openable and closable ink inlet and an ink storage unit for storing the injected ink will now be described. The ink jet recording apparatus includes the above-described aqueous ink jet ink composition.

The ink jet recording apparatus includes the above-described aqueous ink jet ink composition, an ink container for accommodating the aqueous ink jet ink composition, and a recording head for discharging the aqueous ink jet ink composition, and the ink container has an openable and closable ink inlet for loading the aqueous ink jet ink composition.

An example of the ink jet recording apparatus according to an embodiment will be described with reference to drawings. Incidentally, the ink container is an ink tank of an ink jet type printer (ink jet recording apparatus) that records (prints) an image or the like on a medium by discharging an ink toward the medium. In addition, in the following description, the ink jet recording apparatus may be simply referred to as a recording apparatus, and the aqueous ink jet ink composition and the ink composition may be simply referred to as an ink.

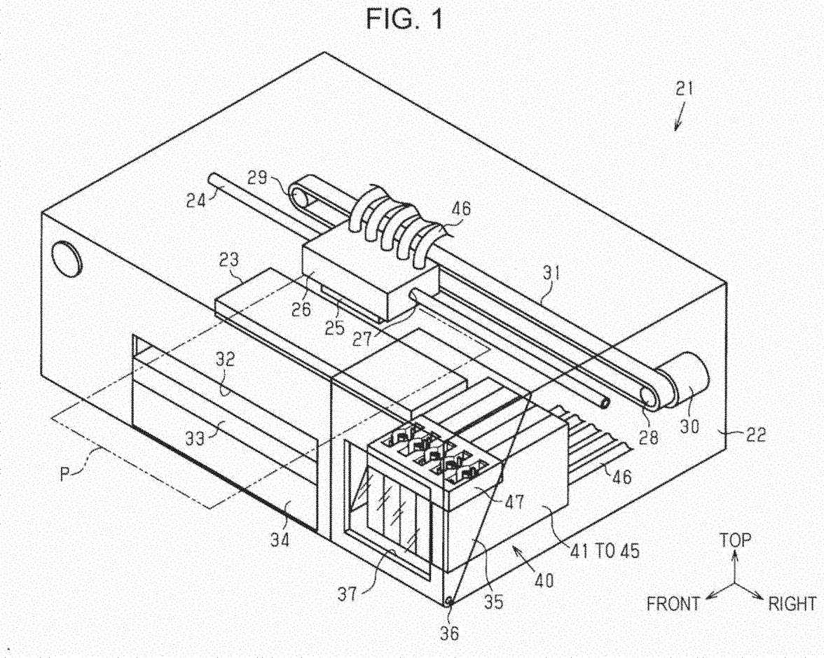

As shown in FIG. 1, the recording apparatus 21 includes a rectangular parallelepiped housing 22 with the left-right direction as the longitudinal direction. Incidentally, FIG. 1 simply shows a perspective view of the inside of the housing 22 of the recording apparatus 21. A support table 23 with the left-right directions as the longitudinal direction is provided in the lower portion near the back in the housing 22 such that the upper surface is aligned substantially in the horizontal direction. Paper P, which is an example of the medium, is transported toward the front as the transporting direction, while being supported by the upper surface of the support table 23. In addition, a guide shaft 24 extending in the left-right direction is installed on the upper position of the support table 23 in the housing 22, and the guide shaft 24 supports a carriage 26 including a recording head 25 for discharging an ink on the lower surface side. That is, the carriage 26 is supported by the guide shaft 24 inserted through a bearing hole 27 passing through the carriage 26 in the left-right direction and can freely reciprocate in the left-right direction with respect to the guide shaft 24.

A driving pulley 28 and a driven pulley 29 are freely rotatably supported at positions near both ends, respectively, of the guide shaft 24 in the housing 22. The driving pulley 28 is connected to the output shaft of a carriage motor 30, and an endless timing belt 31 partially connected to the carriage 26 is wound between the driving pulley 28 and the driven pulley 29. When the carriage 26 reciprocates along the left-right direction, which is the scanning direction for the paper P, while being guided by the guide shaft 24 through the timing belt 31 by driving the carriage motor 30, an ink is discharged from the recording head 25 on the lower surface side of the carriage 26 toward the paper P that is transported to the front on the support table 23.

As shown in FIG. 1, a rectangular outlet 32, which ejects paper P to the front side after recording by discharging the ink from the recording head 25 when transported on the support table 23 in the housing 22, is opened at the position on the front side of the support table 23 on the front surface side of the housing 22. A rectangular tabular ejection tray 33 that can support the paper P ejected from the inside of the housing 22 is provided to the outlet 32 such that it can come out to the front as the ejection direction. In addition, in the outlet 32, a paper cassette 34 that can accommodate a plurality of stacked sheets of paper P to be used in recording is mounted on the lower side of the ejection tray 33 so as to be capable of being freely inserted and extracted in the front-rear direction.

As shown in FIG. 1, an opening-closing door 35 having rectangular front and top surfaces and a right-angled triangular right side surface is mounted on a position on the front surface of the housing 22 and on the end side in the left-right direction than the outlet 32 (in FIG. 1, on the right end side) so as to be openable and closable in the front-rear direction with the rotation shaft 36 provided at the lower end along the left-right direction as the center of rotation. A rectangular window 37 made of a transparent member is formed in the front surface of the opening-closing door 35, and a user can visually recognize the inside (in particular, the rear side of the front surface of the opening-closing door 35) of the housing 22 with the opening-closing door 35 closed.

In the housing 22 of the recording apparatus 21, an ink supply unit 40 for supplying an ink to the recording head 25 is accommodated at a position on the rear side of the opening-closing door 35, i.e., a position near the front surface and near an end (in this case, near the right end). The ink supply unit 40 is a structure including a plurality of (five in the present embodiment) ink tanks 41 to 45 that can be integrally handled, and each of the ink tanks 41 to 45 can be refilled with an ink as described later.

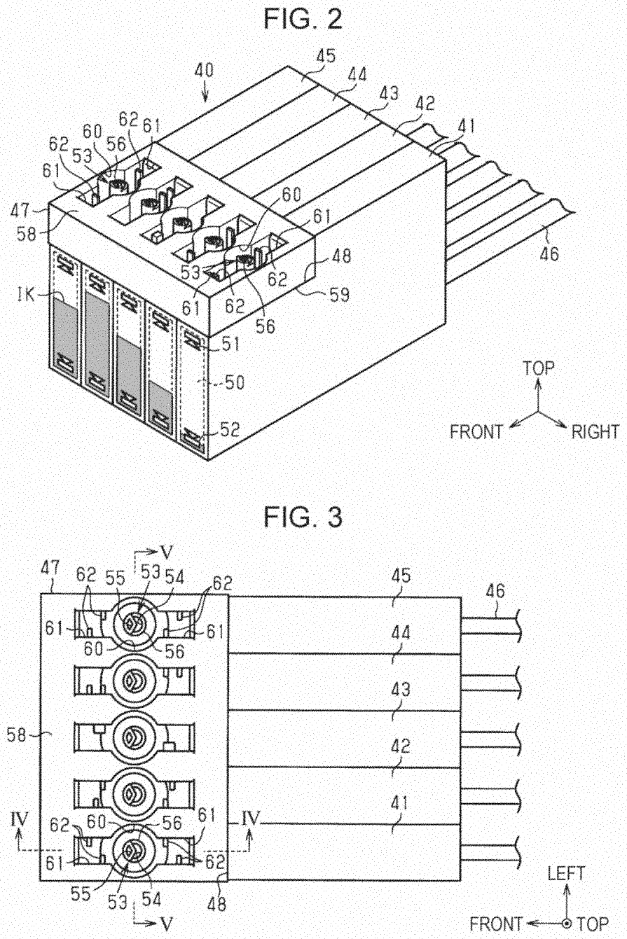

As shown in FIGS. 2 and 3, the ink supply unit 40 is configured by including five ink tanks 41 to 45 having a modified box shape long in the front-rear direction, five ink supply tubes 46 extracted from the back surface side of each of the ink tanks 41 to 45, and a rectangular parallelepiped ink refill adapter 47 assembling the ink tanks 41 to 45 together. This ink refill adapter 47 is attached to stepped portions 48 formed by notching the upper front half of all the ink tanks 41 to 45 arranged side by side with the thickness direction as the left-right direction and is unified with the ink tanks 41 to 45. Incidentally, as shown in FIG. 1, the ink supply tubes 46 extracted from the ink tanks 41 to 45 are connected to ink channels (not shown) formed in the carriage 26 and are connected to the recording head 25 through the ink channels. The ink refill adapter 47 may partially constitute the housing 22 covering the ink tanks 41 to 45 or may be integrally formed together with the ink tanks 41 to 45.

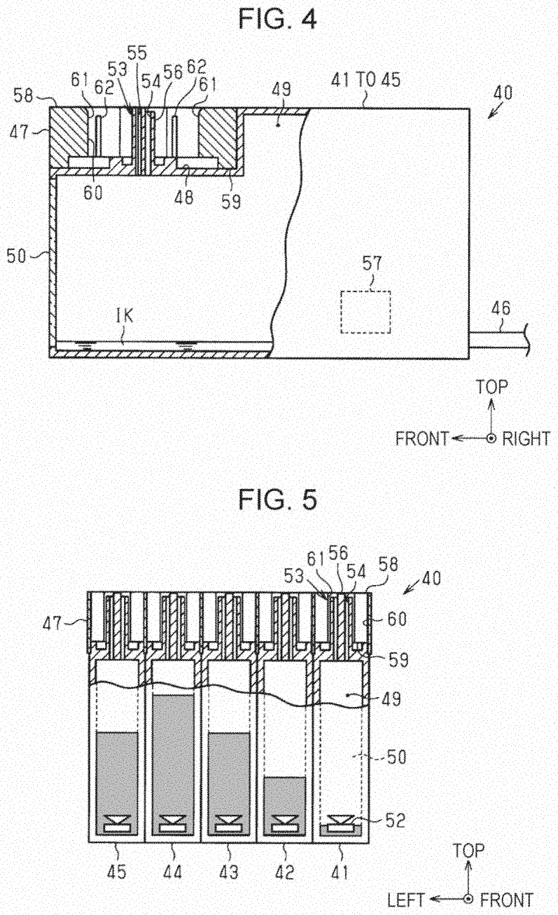

As shown in FIGS. 4 and 5, the ink tanks 41 to 45 each have an ink reservoir 49 that can reserve an ink composition IK therein. In the present embodiment, the ink reservoir 49 of the ink tank 41 located on the right end in the side-by-side direction reserves a black ink. The ink reservoir 49 of each of the other ink tanks 42 to 45 arranged on the left side of the ink tank 41 on the right end in the side-by-side direction reserves a color (such as cyan, magenta, and yellow) ink other than black. In the ink tanks 41 to 45, a visual recognition portion 50 made of a transparent resin that makes the liquid level of the ink composition IK in the ink reservoir 49 is provided in the front wall portion that allows visual recognition through the window 37 of the front surface of the housing 22. A upper limit mark 51 indicating the guideline for the upper limit (an example of the guideline of the amount of ink that can be injected without overflowing the ink from the ink inlet 53) of the liquid level of the ink composition IK reserved in the ink reservoir 49 and a lower limit mark 52 indicating the guideline for the lower limit (for example, a guideline for encouraging ink refill) are marked on the visual recognition portion 50.

As shown in FIG. 4, in the ink tanks 41 to 45, an openable and closable ink inlet 53 (ink inlet) that allows the ink to inflow into the ink reservoir 49 from the outside is provided on the upper side of the horizontal portion of the stepped portion 48. The ink inlet 53 is constituted by including a needle 56 having channels 54 and 55 communicating between the inside of the ink reservoir 49 and the outside and extending vertically upward. The channels 54 and 55 of the needle 56 are composed of two channels 54 and 55 of which the tip openings are arranged side by side in the radial direction with the needle 56 as the center, and one of these two channels 54 and 55, the channel 54 (in FIG. 4, the right one), is formed such that the height of the tip opening is lower and the cross sectional area is larger than those of the other of channels, the channel 55 (in FIG. 4, the left one). Incidentally, a remaining amount sensor 57 for detecting the remaining amount of the ink composition IK in the ink reservoir 49 is provided at the lower portion near the back in the ink reservoir 49. The remaining amount sensor 57 need not to be provided.

As shown in FIGS. 2 to 5, the upper surface 58 of the ink refill adapter 47 is a horizontal surface along a direction orthogonal to (crossing) the needle 56 extending direction, and a through hole 60 passing through vertically from the upper surface 58 to the lower surface 59 is formed as an ink inlet-forming portion. This through hole 60 is composed of the circular hole-shaped ink inlet 53 with the needle 56 at the center and a pair of front and rear rectangular holes extended from the front and back of the ink inlet 53, and the opening on the lower side thereof is closed by the horizontal portion of the stepped portion 48 formed upward by the needle 56 in the ink tanks 41 to 45.

Accordingly, in the through hole 60, in the region outside the ink inlet 53 in the radial direction with the ink inlet 53 as the center, a pair of front and rear rectangular holes of which the openings on the lower side are closed forms a pair of front and rear concavities 61 opened to the upper side in the direction in which the needle 56 extends and with the vertically downward side as the depth direction so as to be point symmetry with each other with respect to the ink inlet 53. That is, in the ink refill adapter 47 unified with the ink tanks 41 to 45, in the region outside the ink inlet 53 including the needle 56, a plurality of (in this case, two of the front and the rear forming a pair) concaviies 61 that are point symmetry with respect to the ink inlet 53 is formed. Incidentally, in this case, the tip of the needle 56 disposed at the center of the circular hole-shaped ink inlet 53 is located on the ink reservoir 49 side than the upper surface 58 of the ink refill adapter 47, which is the opening edge of the through hole 60 including the ink inlet 53 and the concavity 61. That is, the upper surface 58 of the ink refill adapter 47 extends in a direction crossing the direction in which the needle 56 extends at a position outside the tip of the needle 56 in the direction in which the needle 56 extends. On the other hand, the lower surface 59 of the ink refill adapter 47 functions as a tank engaging portion for engaging collectively the plurality of ink tanks 41 to 45 arranged side by side in the left-right direction from the upper side.

In addition, in the upper surface 58 of the ink refill adapter 47, the peripheral portion of the opening edge on the upper side of each through hole 60 is colored to a specific color, that is, colored to the same color as the color of the ink reserved in the ink reservoir 49 of each of the ink tanks 41 to 45 into which the respective inks are inflown through the ink inlets 53 of the through holes 60. In this respect, the peripheral portion of the opening edge on the upper side of each through hole 60 in the ink refill adapter 47 functions as a first portion showing, to the outside, the information relating to the inks reserved in the ink tanks 41 to 45 communicating with the respective ink inlets 53 of the through holes 60 and the ink reservoirs 49. Incidentally, although the inks reserved in the ink tanks 41 to 45 are not particularly limited, if the ink tank to which the ink composition of the present embodiment is supplied from an ink container containing it is defined as the ink tank 41, a black ink of black or gray is reserved. Accordingly, the peripheral portion of the upper side opening of the through hole 60 in which the ink inlet 53 communicating with the ink reservoir 49 of the ink tank 41 is colored to black or gray.

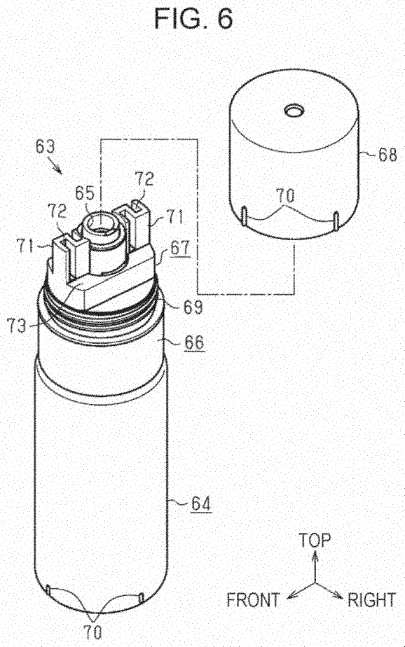

In addition, in the inner surface of the concavity 61 (specifically, inside surface along the vertical direction), a first concavo-convex portion (first key structure portion) 62 having a characteristic concavo-convex shape in the horizontal direction is provided at the position on the bottom surface side than the opening edge of the upper side of the concavity 61 (i.e., on the horizontal portion side of the stepped portion 48) so as to extend along the depth direction of the concavity 61 (in other words, the direction of the central axis of the ink inlet 53). As shown in FIGS. 2 and 3, the first concavo-convex portion 62 is provided for each ink inlet 53 of a plurality of (five in the present embodiment) ink tanks 41 to 45. Accordingly, in the ink refill adapter 47, the first concavo-convex portion 62 that is different from the first concavo-convex portions 62 provided on the inside surfaces of the concavities 61 of other through holes 60 is formed in the rectangular concavity 61 of each of the through holes 60 formed at the positions corresponding to the respective ink tanks 41 to 45 in the vertical direction. That is, these first concavo-convex portions 62 function as discriminating portions that can discriminate an ink container 63 (see, for example, FIG. 6) having an ink outlet 65 (see, for example, FIG. 6) to be connected to the ink inlet 53 in the through hole 60 in which the first concavo-convex portion 62 is formed. Incidentally, the “position on the bottom surface side than the opening edge of the upper side of the concavity 61” means that the position may be any position retracted, even if it is slight, to the bottom surface side than the opening edge.

Then, an ink container 63 will be described as an ink refill container that configures an ink refill system together with the ink tanks 41 to 45 and supplies an ink to an ink tank of which the ink remaining amount is low among the ink tanks 41 to 45. The ink container 63 contains the above-described aqueous ink jet ink composition.

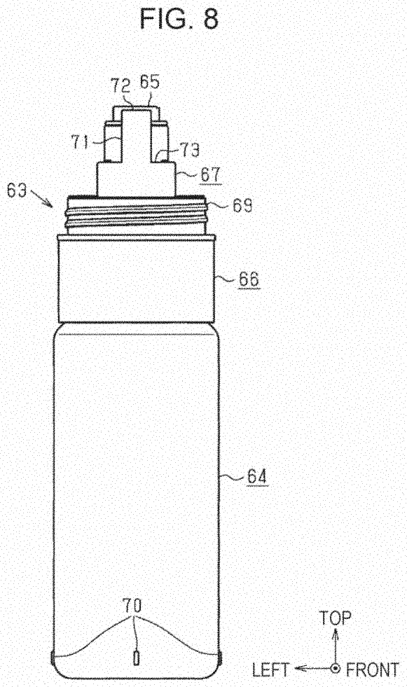

As shown in FIGS. 6 to 8, the ink container 63 includes cylindrical container body 64 as a main constituent, an ink outlet-forming portion 66 that is provided at the top of the container body 64 and has an ink outlet 65 opened at the tip and allowing the ink to flow out from the ink container 63, and a container attachment portion 67 added to the ink outlet-forming portion 66 so as to surround the ink outlet 65. The ink outlet 65 of the ink outlet-forming portion 66 and also the container attachment portion 67 around it are covered with a bottomed cylindrical cap 68 and are therefore hidden from the outside when the ink container 63 is stored. That is, a male threaded portion 69 is formed on the outer circumferential surface of the cylindrical lower end of the container attachment portion 67, and a female threaded portion (not shown) is formed on the inner circumferential surface of the cap 68. The cap 68 is assembled to the top of the ink container 63 so as to cover the ink outlet 65 by screwing the female threaded portion of the cap 68 to the male threaded portion 69 of the container attachment portion 67.

Incidentally, the whole outer surface of the container attachment portion 67 is colored to a specific color. That is, the outer surface is colored to the same color as that of the ink contained in the container body 64 to which the container attachment portion 67 is added. Incidentally, the outer surface of the container attachment portion 67 of the ink container 63 containing a black or gray ink is colored to black or gray. In addition, a plurality (four in the present embodiment) of protrusions 70 is formed with equal angle spacing (90 degree spacing as an example) on the outer circumferential surface of each base end of the container body 64 and the cap 68. Incidentally, these protrusions 70 are formed for preventing rolling of the cylindrical ink container 63. Furthermore, for example, the container body 64 of the ink container 63 containing a black ink may be formed to be thicker than the container body 64 of each of the ink containers 63 containing inks of other colors. In such a case, the ink outlet-forming portions 66 for black ink and other color inks may have the same thickness and shape.

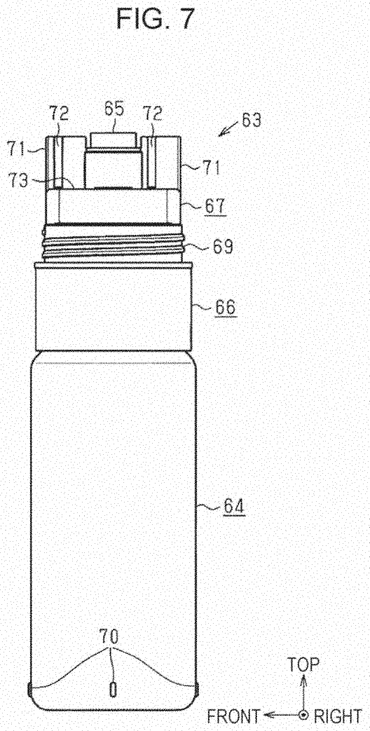

As shown in FIGS. 6 to 8, in the upper portion than the cylindrical lower end where the male threaded portion 69 is formed on the outer circumferential surface of the container attachment portion 67, a convex portion 71 protruding upward than the ink outlet 65 in the direction opposite to the container body 64 in the direction of the central axis of the ink outlet 65 is formed in the region outside the ink outlet 65 in the radial direction with the ink outlet 65 as the center. This convex portion 71 functions as a second joint that can fit into the concavity 61 as a first joint of the upper surface 58 of the ink refill adapter 47 when the tip of the needle 56 on the ink inlet 53 side is inserted into the ink outlet 65, and a pair of the convex portions 71 is provided so as to sandwich the ink outlet 65 from the front and back as in a pair of the concavities 61 sandwiching the ink inlet 53 from the front and back. Incidentally, as shown in FIGS. 6 and 7, the convex portion 71 is formed on the inner side than the outer circumferential surface of the container body 64 in the radial direction with the ink outlet 65 as the center in the ink container 63.

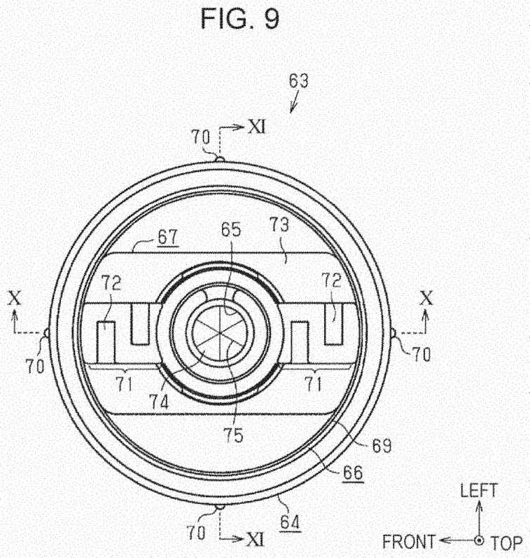

As shown in FIGS. 6 and 9, a second concavo-convex portion (second key structure portion) 72 that can engage with the first concavo-convex portion (first key structure portion) 62 formed on the inner surface of the concavity 61 of the ink refill adapter 47 is formed on the outer surface of each convex portion 71 (in FIGS. 6 and 9, both light and right side surfaces). This second concavo-convex portion 72 is provided so as to extend along the protruding direction (in other words, the direction of the central axis of the ink outlet 65) of the convex portion 71 and connects the ink outlet 65 of the ink container 63 to the ink inlet 53 on the ink tanks 41 to 45 side when the convex portion 71 is fit into the concavity 61 and the second concavo-convex portion 72 is engaged with the first concavo-convex portion 62.

A planar positioning portion 73 orthogonal to (crossing) the central axis of the ink outlet 65 is provided to the container attachment portion 67 between the cylindrical lower end where the male threaded portion 69 is formed and the convex portion 71 where the second concavo-convex portion 72 is formed so as to be located on the outside of the ink outlet 65 in the radial direction when the ink outlet 65 is viewed in the direction of its central axis. That is, this positioning portion 73 constitutes a part of the outer surface of the container attachment portion 67 as a part of the outer surface of the ink container 63 and is provided at a position on the container body 64 side than the tip of the convex portion 71 in the direction of the central axis of the ink outlet 65. Since this positioning portion 73 is provided in the container attachment portion 67 added to the ink outlet-forming portion 66 in the ink container 63, it is said that the positioning portion 73 is a structure of a member different from the ink outlet-forming portion 66 and a structure provided on the outside of the ink outlet-forming portion 66.

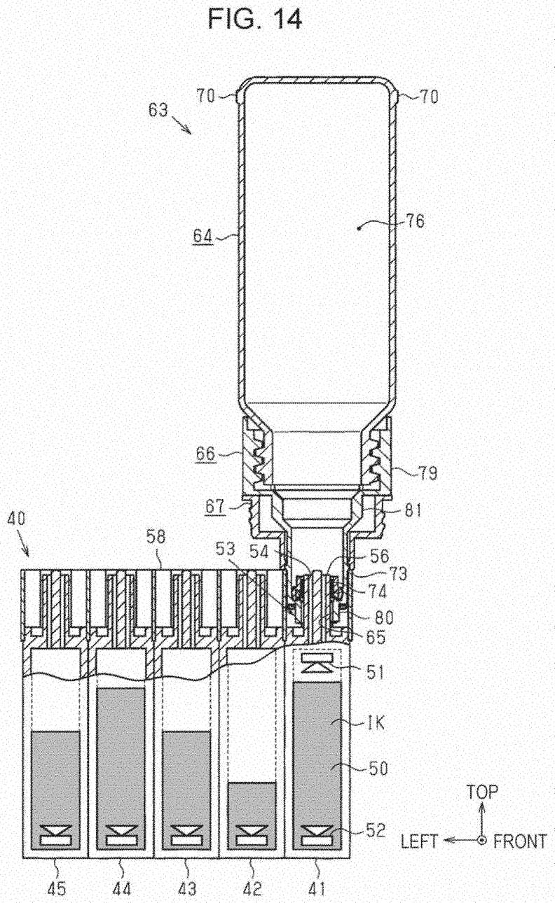

In addition, as shown in FIG. 9, a valve 74 made of an elastic member, such as a silicon film, for openably sealing the ink outlet 65 is provided in the ink outlet 65 formed in the ink outlet-forming portion 66. The valve 74 is located such that the positioning portion 73 is on the container body 64 side in the direction of the central axis of the ink outlet 65 (for example, see FIG. 14). This valve 74 is provided with a plurality (three in this embodiment) of slits 75 that intersect with equal angle spacing (120 degree spacing as an example) with the center as the intersection and is configured to be opened by spreading the slits 75 from the outside of the ink outlet 65 to the inside. That is, the valve 74, which is a normally closed valve, is opened by being spread to the inside with the tip of the needle 56 when the tip of the needle 56 on the ink inlet 53 side is inserted into the ink outlet 65.

At that time, the positioning portion 73 is in contact with the ink inlet 53 and the upper surface 58 of the ink refill adapter 47 where the through hole 60 including the concavity 61 is formed at the outside of the ink outlet 65 in the radial direction and positions the valve 74 with respect to the ink tanks 41 to 45 in the direction of the central axis of the ink outlet 65. On this point, the upper surface 58 of the ink refill adapter 47 is a part of the ink tanks 41 to 45 side with which the positioning portion 73 of the ink container 63 comes into contact when the valve 74 of the ink outlet 65 of the ink container 63 is opened for supplying an ink to any of the ink tanks 41 to 45 and functions as a receiving surface for receiving the planar positioning portion 73.

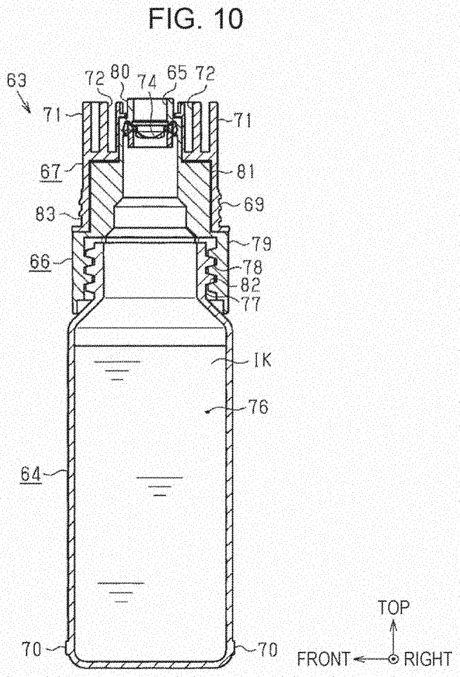

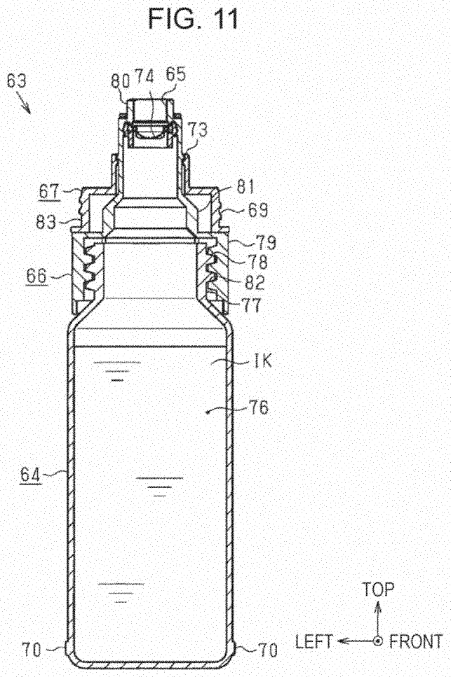

As shown in FIGS. 10 and 11, the container body 64 in the ink container 63 is a member having a bottle-like shape and including an ink containing chamber 76 that can contain the ink composition IK therein, and a male threaded portion 78 is formed on the outer circumferential surface of the neck portion 77 at the upper end. On the other hand, the ink outlet-forming portion 66 disposed at the upper end of the container body 64 includes a large-diameter portion 79 located on the outer circumference side of the neck portion 77 of the container body 64, a small-diameter portion 80 forming the ink outlet 65 at a position farthest from the container body 64, and an intermediate portion 81 connecting between the large-diameter portion 79 and the small-diameter portion 80. The ink outlet-forming portion 66 is assembled to the upper end of the container body 64 by screwing the female threaded portion 82 formed on the inner circumferential surface of the large-diameter portion 79 to the male threaded portion 78 formed on the outer circumferential surface of the neck portion 77 of the container body 64.

In the container attachment portion 67 appended to the ink outlet-forming portion 66 in the ink container 63 so as to surround the ink outlet 65, the cylindrical lower end where the male threaded portion 69 is formed on the outer circumferential surface thereof constitutes a junction 83 of which the lower end surface is in contact with the upper end surface of the large-diameter portion 79 of the ink outlet-forming portion 66. This junction 83 is connected to the large-diameter portion 79 of the ink outlet-forming portion 66 by that the surface regions facing in the front-rear direction of the inner circumferential surface are in surface contact with the front outer surface and the rear outer surface of the intermediate portion 81 of the ink outlet-forming portion 66.

The operation of the ink refill system configured as described above will now be described by focusing on the effect when refilling the ink tanks 41 to 45 of the ink supply unit 40 with inks by using the ink container 63.

On the assumption that, as shown in FIG. 2, the liquid level of the ink in the ink tank 41 for a black ink located on the rightmost side among a plurality of the ink tanks 41 to 45 arranged side by side is lowered to the height of the lower limit mark 52 marked at the lower portion of the visual recognition portion 50, a case of refilling this ink tank 41 with an ink will be described below. The ink container 63 to be used for ink refilling contains a sufficient amount of a black ink, and the cap 68 is removed from the ink container 63 in advance. Furthermore, the shape of the second concavo-convex portion 72 formed on the outer surface of the convex portion 71 of the ink container 63 coincides with the shape of the first concavo-convex portion 62 formed on the inner surface of the concavity 61 located at the front and rear of the ink inlet 53 for the ink tank 41, and they can be engaged with each other by inserting the convex portion 71 into the concavity 61.

When the ink tank 41 is refilled with an ink, the user first rotates the opening-closing door 35 of the housing 22 forward with the rotation shaft 36 with the center to change the closed state shown in FIG. 1 to the opened state. Consequently, in the ink supply unit 40, the upper surface 58 of the ink refill adapter 47 where the ink inlets 53 for the ink tanks 41 to 45 are formed is exposed to the outside of the housing 22, the user can connect the ink outlet 65 of an ink container 63 to a desired ink inlet 53 from above.

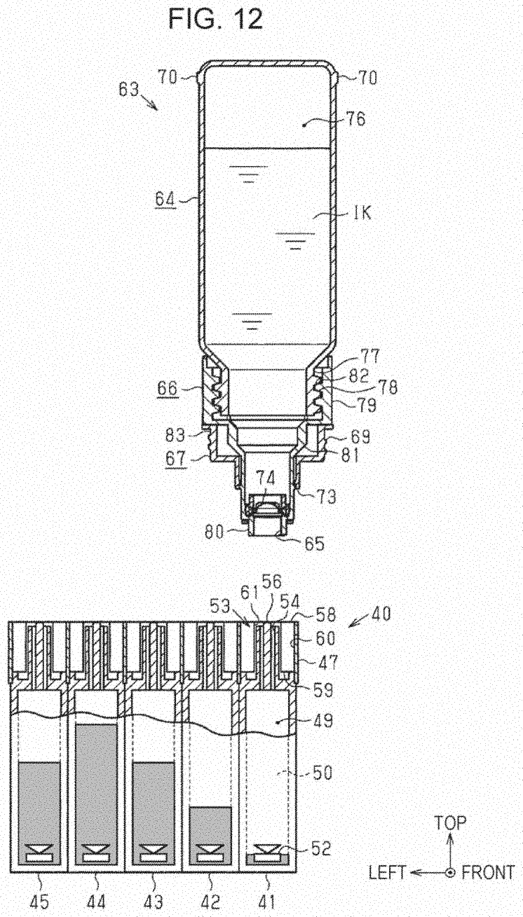

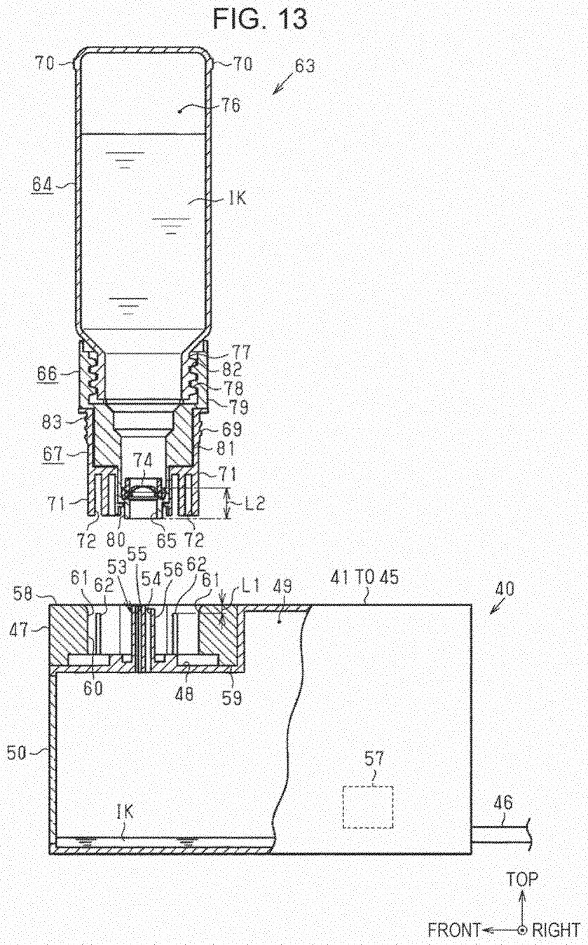

Accordingly, as shown in FIGS. 12 and 13, the user turns the ink container 63 containing the ink composition to be used for ink refilling upside down and holds the ink container 63 such that the ink outlet 65 is positioned above the through hole 60 on the rightmost side in the ink refill adapter 47. That is, the central axial line of the ink outlet 65 of the ink container 63 is adjusted with the central axial line of the ink inlet 53 of the ink tank 41 as the target of ink refilling. On this occasion, the user compares the color (second portion) colored on the container attachment portion 67 of the ink container 63 held in the hand with the color (first portion) colored around the opening edge on the upper side of the through hole 60 provided with the ink inlet 53 of the ink tank 41 as the target for ink refilling at that time. When the colors of both are the same (in this case, both are black), it is confirmed that the user is holding the ink container 63 suitable for ink refilling this time and moves on to subsequent work for ink refilling.

The ink container 63 is lowered from the state shown in FIGS. 12 and 13, and the convex portion 71 of the ink container 63 is inserted into the concavity 61 of the ink refill adapter 47 united to the ink tank 41. Consequently, the achievement of the insertion state of the convex portion 71 into the concavity 61 secures the state in which the central axial line of the ink outlet 65 coincides with the central axial line of the ink inlet 53. In this case, since the concavity 61 is in a point-symmetrical position state with respect to the needle 56 as the center of the ink inlet 53, the convex portion 71 can be inserted into any concavity 61. Accordingly, it is not necessary to check the compatible positional relation between the concavity 61 and the convex portion 71 by rotating the ink container 63 many times with the central axial line of the ink outlet 65 as the center, and the user can easily perform the insertion of the convex portion 71 into the concavity 61.

However, at this point, when the convex portion 71 is only slightly inserted into the concavity 61, the tip of the needle 56 located at the center of the ink inlet 53 is also inserted into the opening of the ink outlet 65 slightly protruding than the tip of the convex portion 71 but does not reach the valve 74 located at the inner part of the ink outlet 65. The reason of this is that, as shown in FIG. 13, the distance L2 between the tip of the convex portion 71 and the valve 74 in the ink outlet 65 is longer than the distance L1 between the upper surface 58 of the ink refill adapter 47 where the opening edge of the concavity 61 is located and the upper end of the first concavo-convex portion 62 in the concavity 61. Accordingly, the second concavo-convex portion 72 of the outer surface of the convex portion 71 is engaged with the first concavo-convex portion 62 on the inner surface of the concavity 61 by further inserting the convex portion 71 in the above state downward in the depth direction of the concavity 61. The tip of the needle 56 of the ink inlet 53 reaches the position of the valve 74 of the ink outlet 65 to open the valve 74 by further inserting the convex portion 71 toward the bottom side in the depth direction of the concavity 61 while maintaining the engaging condition.

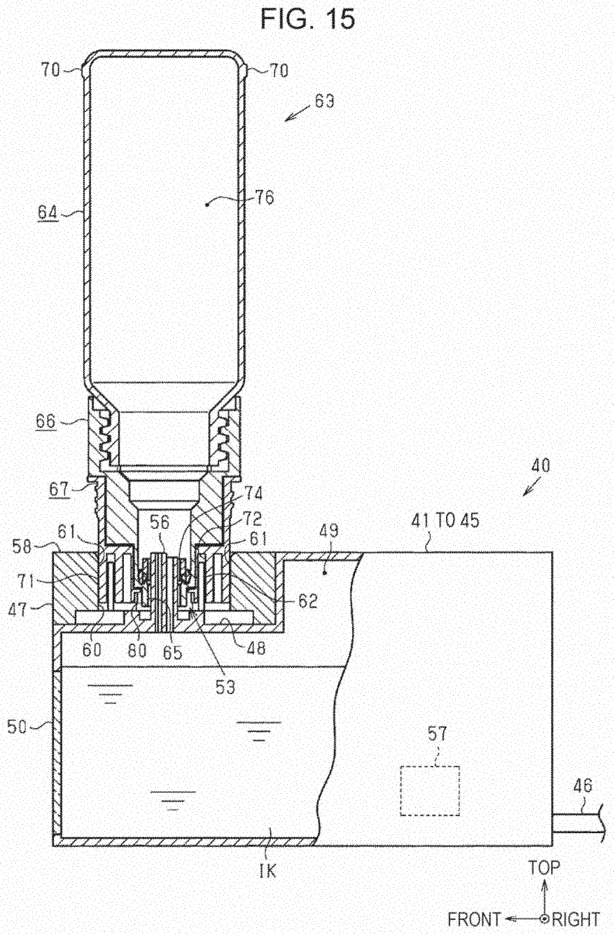

That is, as shown in FIGS. 14 and 15, the valve 74 is opened by spreading the slits 75 from the lower side to the upper side with respect to the valve 74 (i.e., from the outside to the inside of the ink outlet 65) by the tip of the needle 56. As a result, the ink outlet 65 of the ink container 63 and the needle 56 of the ink inlet 53 of the ink tank 41 are connected to each other, and the refilling of the ink composition from the ink container 63 into the ink tank 41 is performed. On this occasion, the needle 56 of the ink inlet 53 opens the valve 74, and one of two channels 54 and 55 of which the tip opening is brought into earlier contact with the ink flowing out from the ink outlet 65 functions as an ink channel for distributing the ink, and the other channel functions as an air channel for distributing the air. For example, when the user tries to connect the ink outlet 65 to the ink inlet 53 with the ink container 63 tilted, one of the two channels 54 and 55 that functions as an ink channel is changed depending on the tilting direction.

When the second concavo-convex portion 72 is not engaged with the first concavo-convex portion 62 after insertion of the convex portion 71 into the concavity 61, at that point, the user can recognize that an ink container 63 of a color other than black is being inserted incorrectly. In this case, if the configuration is that the upper end of the first concavo-convex portion 62 is located at the same height as that of the opening edge of the concavity 61 not only rejection of the engagement of the second concavo-convex portion 72 with the first concavo-convex portion 62, but also rejection of the insertion of the convex portion 71 into the concavity 61 occur. Accordingly, the user may try to insert the convex portion 71 into the concavity 61 repeatedly to waste work time unnecessarily. Regarding this point, in the present embodiment, since the height of the first concavo-convex portion 62 is lower than that of the opening edge of the concavity 61, the convex portion 71 is easily guided to the bottom side of the concavity 61 in the depth direction when inserted into the concavity 61 to prevent the work time from becoming longer unnecessarily.

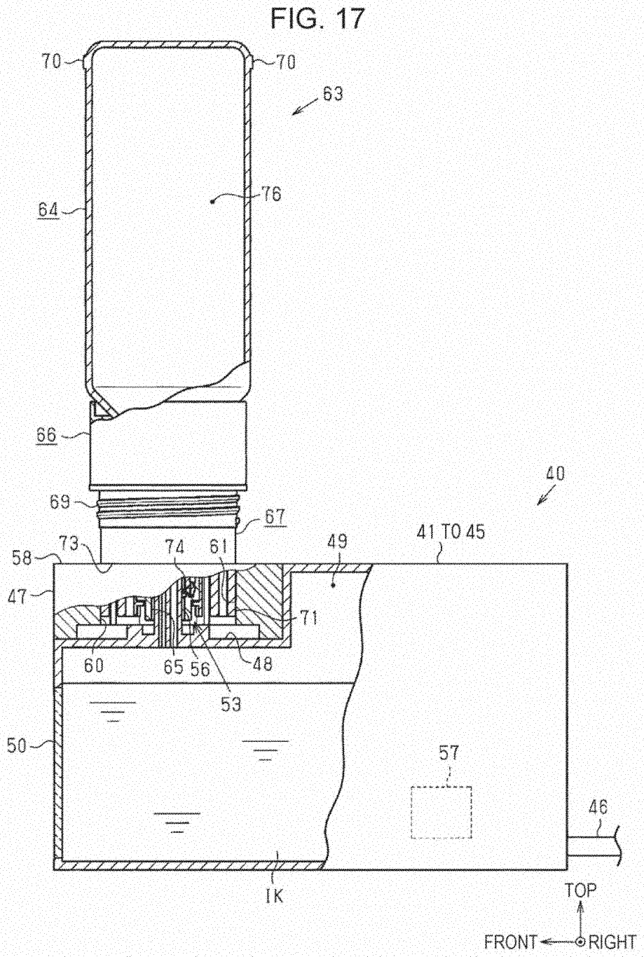

Furthermore, as shown in FIGS. 14, 16, and 17, when the valve 74 in the ink outlet 65 of the ink container 63 is opened by the needle 56 of the ink inlet 53 on the ink tank 41 side, the positioning portion 73 of the ink container 63 is brought into contact with the upper surface 58 of the ink refill adapter 47 which is a part of the ink tank 41 side. That is, the valve 74 of the ink container 63 is opened by this contact between the positioning portion 73 and the upper surface 58 of the ink refill adapter 47 in the state in which the valve 74 is positioned in the direction of the central axis of the ink outlet 65 with respect to the needle 56 of the ink tank 41 side.

In addition, at that time, since the positioning portion 73 is located on the outside of the ink outlet 65 in the radical direction, the ink container 63 is stably maintained in the state in which the ink outlet 65 is connected to the ink inlet 53. As shown in FIGS. 14 and 15, when the positioning portion 73 of the ink container 63 is in contact with the upper surface 58 of the ink refill adapter 47, a gap is present between the bottom surface of the ink inlet 53 where the base end of the needle 56 is located in the ink inlet 53 and the tip of the ink outlet 65 of the ink container 63. Accordingly, an ink is likely to remain on the bottom surface where the base end of the needle 56 of the ink inlet 53 is located, and the remaining ink adheres to the tip of the ink outlet 65 to avoid contamination of the ink container 63.

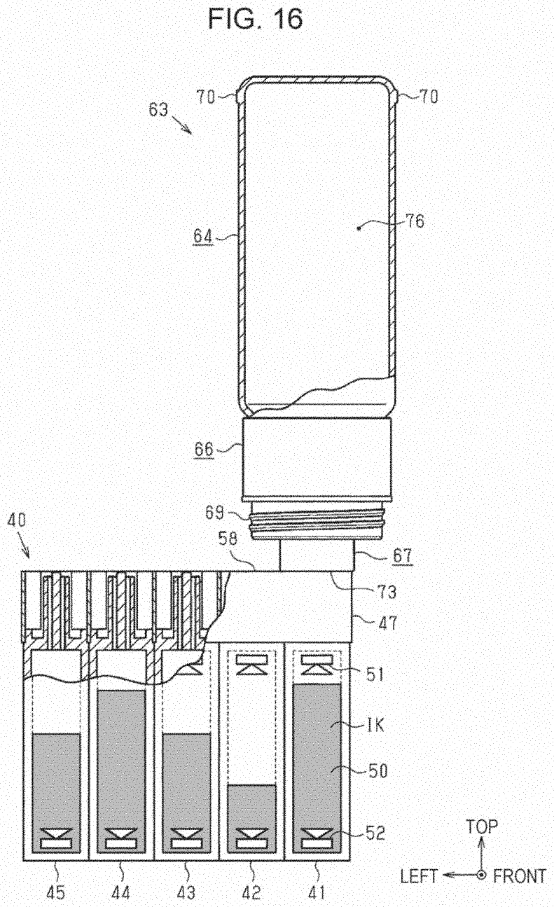

As shown in FIGS. 14 and 16, when the liquid level of the ink in the ink tank 41 is still lower than the upper limit mark 51 of the visual recognition portion 50 at the time of end of the ink refilling to the ink tank 41 from the ink container 63, ink refilling for further adding the ink up to the upper limit mark 51 may be performed using the same black ink container 63. Incidentally, the ink refilling work described above is similarly performed for the ink tanks 42 to 45 of other colors other than the ink tank 41 of the ink composition (ink composition of black or gray).

According to this ink jet recording apparatus, since a user can refill an aqueous ink jet ink composition by the presence of the ink inlet, there is no need to, for example, replace the container, and the convenience is good. In addition, even if the ink inlet is opened to cause a state in which the solvent of the aqueous ink jet ink composition is likely to volatilize, good dispersion stability of the color material of the aqueous ink jet ink composition is likely to be maintained.

### 3. Ink Jet Recording Method

The ink jet recording method of the present embodiment includes discharging the above-described aqueous ink jet ink composition from a recording head to adhere the composition to a recording medium. That is, the ink jet recording method of the present embodiment includes a step of discharging the above-described aqueous ink jet ink composition from a recording head to adhere the composition to a recording medium.

The recording medium is not particularly limited and may be a recording medium having a recording surface that absorbs a liquid or may be a recording medium not having a recording surface that absorbs a liquid. Accordingly, the recording medium is not particularly limited, and, for example, paper, a film, a fabric, a metal, glass, and a polymer can be used. In addition, transfer paper for performing sublimation transfer to a recording medium can also be a recording medium. When the recording medium is paper containing cellulose, non-woven fabric, etc., since curling is likely to occur after recording, the curling-suppressing effect by the ink jet recording method of the present embodiment is more remarkably expressed.

The step of adhering the aqueous ink jet ink composition to a recording medium can be performed by using the above-described ink jet recording apparatus. That is, the step of adhering the aqueous ink jet ink composition to a recording medium can be performed by filling the recording head with the aqueous ink jet ink composition such that the composition can be discharged from a predetermined nozzle and discharging the composition in this state to the recording medium at a predetermined timing.

In addition, the recording method of the present embodiment may appropriately include a step of heating a recording medium. The step of heating a recording medium can be performed by, for example, using the above-described drying means when an ink jet recording apparatus is used. In addition, the step can be performed by an appropriate drying means not limited to the ink jet recording apparatus. Consequently, the resulting image is dried to allow the bleeding of the image to be suppressed and the image to be more efficiently fixed.

The recording method of the present embodiment can further appropriately include another step, such as a step of applying another composition or a washing step. In the recording method of the present embodiment, since the above-described aqueous ink jet ink composition is used, stable recording can be performed due to the good discharge stability and good clogging recovery.

According to this ink jet recording method, as a result of using the above-described aqueous ink jet ink composition, curling of the recording medium is unlikely to occur after recording.

### 4. Examples

The present disclosure will now be further specifically described by Examples but is not limited to these Examples. Hereinafter, “%” is on a mass basis unless otherwise specified.

### 4.1. Preparation of Aqueous Ink Jet Ink Composition

Aqueous ink jet ink compositions according to Examples and Comparative Examples were obtained by placing each of components in respective containers so as to give the compositions shown in Tables 1 and 2, mixing and stirring them with a magnetic stirrer for 2 hours, and then filtering each of the mixtures through a membrane filter with a pore diameter of 5 μm.

TABLE 1

| | | Example 1 | Example 2 | Example 3 | Example 4 | Example 5 | Example 6 | Example 7 | Example 8 |
|---|---|---|---|---|---|---|---|---|---|
| 1-(2-Hydroxyethyl)-2-pyrrolidone | | 2.0 | 2.0 | 2.0 | 2.0 | 5.0 | 6.0 | 1.0 | 2.0 |
| Polyhydric alcohol | Glycerol (290° C.) | 8.0 | 5.0 | 9.0 | 9.0 | 9.0 | 11.0 | 3.0 | 8.0 |
| having standard | Triethylene glycol (287.4° C.) | 1.0 | 1.5 | 5.0 | 4.0 | 10.0 | 11.0 | 1.0 | 1.0 |
| boiling point of | | | | | | | | | |
| 270° C. or more | | | | | | | | | |
| Color material | Self-dispersible carbon black | 5.0 | 5.0 | 5.0 | 5.0 | 5.0 | 5.0 | 5.0 | 5.0 |
| | pigment | | | | | | | | |
| Resin | Resin EM | 2.0 | 2.0 | 2.0 | 2.0 | 2.0 | 2.0 | 2.0 | 2.0 |
| Other | Trimethyl glycine | 5.0 | 5.0 | 5.0 | 5.0 | 5.0 | 5.0 | 5.0 | — |
| components | TEGmBE | 4.0 | 4.0 | 4.0 | 4.0 | 4.0 | 4.0 | 4.0 | 4.0 |
| | 1,2-HD | 1.5 | 1.5 | 1.5 | 1.5 | 1.5 | 1.5 | 1.5 | 1.5 |
| | Olfine E1010 | 1.5 | 1.5 | 1.5 | 1.5 | 1.5 | 1.5 | 1.5 | 1.5 |
| Water | Pure water | Remaining | Remaining | Remaining | Remaining | Remaining | Remaining | Remaining | Remaining |
| | | amount | amount | amount | amount | amount | amount | amount | amount |
| Ink | Amount of polyhydric alcohol | 9.0 | 6.5 | 14.0 | 13.0 | 19.0 | 22.0 | 4.0 | 9.0 |
| characteristics | having boiling point of | | | | | | | | |
| | 270° C. or more | | | | | | | | |
| | Ratio of polyhydric alcohol | 4.5 | 3.3 | 7.0 | 6.5 | 3.8 | 3.7 | 4.0 | 4.5 |
| | to HEP | | | | | | | | |
| Evaluation | Curling evaluation | A | A | B | A | A | A | B | A |
| result | Clogging recovery | A | B | A | A | A | A | B | B |
| | Line marker resistance | A | A | B | A | B | B | A | A |
| | Printing stability | B | B | A | A | A | A | C | B |

TABLE 2

| | | | | Compar- | Compar- | Compar- | Compar- | Compar- | Compar- |
|---|---|---|---|---|---|---|---|---|---|
| | | | | ative | ative | ative | ative | ative | ative |
| | | Example 9 | Example 10 | Example 1 | Example 2 | Example 3 | Example 4 | Example 5 | Example 6 |
| 1-(2-Hydroxyethyl)-2-pyrrolidone | | 2.0 | 2.0 | — | 10.0 | 2.0 | 1.0 | 2.0 | 5.0 |
| Polyhydric alcohol | Glycerol (290° C.) | 8.0 | 9.0 | 8.0 | — | 5.0 | 8.0 | 10.0 | 8.0 |
| having standard | Triethylene glycol (287.4° C.) | 1.0 | 0.0 | 3.0 | — | 1.0 | 1.0 | 12.0 | 1.0 |
| boiling point of | | | | | | | | | |
| 270° C. or more | | | | | | | | | |
| Color material | Self-dispersible carbon black | 5.0 | 5.0 | 5.0 | 5.0 | 5.0 | 5.0 | 5.0 | 5.0 |
| | pigment | | | | | | | | |
| Resin | Resin EM | — | 2.0 | 2.0 | 2.0 | 2.0 | 2.0 | 2.0 | 2.0 |
| Other | Trimethyl glycine | 5.0 | 5.0 | 5.0 | 5.0 | 5.0 | 5.0 | 5.0 | 5.0 |
| components | TEGmBE | 4.0 | 4.0 | 4.0 | 4.0 | 4.0 | 4.0 | 4.0 | 4.0 |
| | 1,2-HD | 1.5 | 1.5 | 1.5 | 1.5 | 1.5 | 1.5 | 1.5 | 1.5 |
| | Olfine E1010 | 1.5 | 1.5 | 1.5 | 1.5 | 1.5 | 1.5 | 1.5 | 1.5 |
| Water | Pure water | Remaining | Remaining | Remaining | Remaining | Remaining | Remaining | Remaining | Remaining |
| | | amount | amount | amount | amount | amount | amount | amount | amount |
| Ink | Amount of polyhydric alcohol | 9.0 | 9.0 | 11.0 | — | 6.0 | 9.0 | 22.0 | 9.0 |
| characteristics | having boiling point of | | | | | | | | |
| | 270° C. or more | | | | | | | | |
| | Ratio of polyhydric alcohol | 4.5 | 4.5 | — | — | 3.0 | 9.0 | 11.0 | 1.8 |
| | to HEP | | | | | | | | |
| Evaluation | Curling evaluation | A | A | C | A | A | C | C | A |
| result | Clogging recovery | A | B | A | C | C | A | A | C |
| | Line marker resistance | B | A | B | B | A | C | C | B |
| | Printing stability | B | B | B | D | B | B | A | B |

In the tables, components expressed by abbreviations and trade names are as follows.

Self-dispersible carbon black pigment: trade name “CAB-O-JET (registered trademark) 300”, manufactured by Cabot Corporation (Incidentally, the numerical values in the tables represent the solid contents.)

Resin EM: SUPERFLEX 420: (trade name, manufactured by DKS Co., Ltd., urethane resin emulsion, incidentally, the numerical values in the tables represent the solid contents.)

TEGmBE: triethylene glycol monobutyl ether

1,2-HD: 1,2-Hexanediol

Olfine E1010: acetylene glycol surfactant (manufactured by Nissin Chemical Co., Ltd.

In the tables, the standard boiling points of glycerol and triethylene glycol are shown in the parentheses. Furthermore, in the tables, the mass ratios of the total amount of polyhydric alcohols having a standard boiling point of 270.0° C. or more or the content of the polyhydric alcohol to the content of HEP are shown.

### 4.2. Method of Evaluation

### 4.2.1. Evaluation of Curling

The ink pack of PX-M886X (serial ink jet printer) manufactured by SEIKO EPSON CORPORATION was filled with an ink, and a solid pattern was printed at print duty 100% on a recording medium (Xerox P paper of size A4, copy sheet manufactured by FUJIFILM Business Innovation Corp., basis weight: 64 g/m², paper thickness 88 μm) in an environment of 25° C. and a humidity of 50%. After the printing, the paper was left with the face up for 1 week, and the lift-up amount of the paper end from the floor surface was measured. The results of evaluation by the following criteria are shown in Tables 1 and 2.

A: lift-up amount of less than 10 mm,

B: lift-up amount of 10 mm or more and less than 20 mm,

C: lift-up amount of 20 mm or more.

### 4.2.2. Clogging Recovery

The ink pack of PX-M886X (serial ink jet printer) manufactured by SEIKO EPSON CORPORATION was filled with an ink and was left in an environment of 40° C. and a humidity of 25% with the cap removed for 7 days. After the leaving, printing of a nozzle check pattern and cleaning were repeated. The results of evaluation by the following criteria are shown in Tables 1 and 2.

A: discharge of all nozzles is recovered by cleaning 3 or less times,

B: discharge of all nozzles is recovered by cleaning 6 or less times, and

C: discharge of all nozzles is recovered by cleaning 7 or more times.

### 4.2.3. Line Marker Resistance

The ink pack of PX-M886X (serial ink jet printer) manufactured by SEIKO EPSON CORPORATION was filled with inks, and each color character pattern was printed on a recording medium (Xerox P paper of size A4, copy sheet manufactured by FUJIFILM Business Innovation Corp., basis weight: 64 g/m², paper thickness 88 μm) in an environment of 25° C. and a humidity of 50%. The printed matters were left at ordinary temperature and humidity for 5 minutes and were then line-marked with Zebra highlighter 300 gf. The results of evaluation by the following criteria are shown in Tables 1 and 2.

A: slight bleeding by marking twice,

B: not bleeding by marking once, and

C: bleeding by marking once.

### 4.2.4. Evaluation of Printing Stability for Long-Term Use of Printer

The ink container of an ink jet printer (manufactured by SEIKO EPSON CORPORATION, “EW-M660FT”) was filled with an ink of Examples and Comparative Examples up to ⅓ of the container capacity, followed by leaving at 40° C. and 20 RH % for 4 weeks. Subsequently, the same ink was refilled by another ⅓ (total: ⅔ of the container capacity), followed by leaving again at 40° C. and 20 RH % for 4 weeks. The same procedure was repeated once more, and after leaving at 40° C. and 20 RH % for 12 weeks, nozzle check→cleaning operation→nozzle check were performed. The results of evaluation by the following criteria are shown in Tables 1 and 2. Here, normal discharge means that all nozzles discharge an ink without omission and curved flight. Incidentally, “EW-M660FT” is a printer including an openable and closable ink inlet and an ink storage unit for storing the injected ink, as shown in FIG. 1.

A: normal discharge without cleaning,

B: normal discharge by cleaning once,

C: normal discharge by cleaning two or three times, and

D: no normal discharge even after cleaning three times.

### 4.3. Evaluation Results

It was revealed that the aqueous ink jet ink composition of each Example containing a color material, water, a polyhydric alcohol having a standard boiling point of 270.0° C. or more, and 1-(2-hydroxyethyl)-2-pyrrolidone and having a mass ratio of the content of the polyhydric alcohol having a standard boiling point of 270.0° C. or more to the content of 1-(2-hydroxyethyl)-2-pyrrolidone of 3.1 or more and 7.0 or less shows good curling resistance and good clogging recovery.

The above-described embodiments and modifications are merely examples, and the present disclosure is not limited thereto. For example, it is possible to appropriately combine each embodiment and each modification.

The present disclosure includes configurations that are substantially the same as those described in the embodiments, for example, a configuration having the same function, method, and result or a configuration having the same purpose and effect. In addition, the present disclosure includes configurations in which non-essential parts of the configurations described in the embodiments are replaced. In addition, the present disclosure includes configurations that have the same effects or achieve the same purposes as those of the configurations described in the embodiments. Furthermore, the present disclosure includes configurations in which known techniques are added to the configurations described in the embodiments.

The following contents are derived from the above-described embodiments and modifications.

The aqueous ink jet ink composition is an aqueous ink jet ink composition containing:

a color material, water, a polyhydric alcohol having a standard boiling point of 270.0° C. or more, and 1-(2-hydroxyethyl)-2-pyrrolidone, wherein

the mass ratio of the content of the polyhydric alcohol to the content of 1-(2-hydroxyethyl)-2-pyrrolidone is 3.1 or more and 7.0 or less.

According to the aqueous ink jet ink composition, the rate of volatilization after adhesion to the surface of a recording medium is suppressed by the influence of the high standard boiling point (304° C.) of 1-(2-hydroxyethyl)-2-pyrrolidone, and the surface of the recording medium is likely to maintain the wet state with the solvent. Consequently, curling of a recording medium including cellulose can be particularly suppressed. In addition, since 1-(2-hydroxyethyl)-2-pyrrolidone has a bulky three-dimensional structure, it is possible to form looser hydrogen bonds or delay the formation of the bonds when hydrogen bonds are reconstructed with progress of drying, compared to when other solvents, such as a polyhydric alcohol and water, are dried. Consequently, 1-(2-hydroxyethyl)-2-pyrrolidone can contribute to also suppression of contraction by drying of, particularly, a recording medium containing cellulose.

The polyhydric alcohol having a standard boiling point of 270.0° C. or more has a plurality of hydroxy groups and can thereby enhance the moisture absorbing and retaining properties of the aqueous ink jet ink composition. Accordingly, the polyhydric alcohol works effectively in terms of suppressing curling of the recording medium also in that sudden volatilization of a solvent, such as water, from the recording medium can be suppressed.

In the aqueous ink jet ink composition, the content of the polyhydric alcohol may be 5.0 mass % or more and 20.0 mass % or less based on the total amount of the aqueous ink jet ink composition.

According to this aqueous ink jet ink composition, an effect of suppressing curling of the recording medium is further obtained, and the dispersion stability of the color material in the aqueous ink jet ink composition can be further improved when the content is 20.0 mass % or less.

In the aqueous ink jet ink composition,

the polyhydric alcohol may have a standard boiling point of less than 304° C.

According to this aqueous ink jet ink composition, 1-(2-hydroxyethyl)-2-pyrrolidone is likely to remain in the solvent until the end of drying, and the recombination of hydrogen bonds is likely to be delayed. Accordingly, curling of the recording medium can be further suppressed.

In the above aqueous ink jet ink composition, the color material may be a pigment.

According to this aqueous ink jet ink composition, the effect by the solvent composition of maintaining good dispersion stability is more remarkable.

In the above aqueous ink jet ink composition, the composition may be used by being loaded in a recording apparatus that includes an openable and closable ink inlet and an ink storage unit for storing the injected ink.

According to this aqueous ink jet ink composition, even if the composition is applied to a recording apparatus including an ink storage unit having a risk of moisture loss from the inlet portion, the good dispersion stability of the color material can be maintained. In general, in an ink containing a polyhydric alcohol only and not containing 1-(2-hydroxyethyl)-2-pyrrolidone, when moisture is evaporated to increase the content proportion of the polyhydric alcohol, the dispersion stability of the color material is likely to decrease. In contrast, since the aqueous ink jet ink composition contains 1-(2-hydroxyethyl)-2-pyrrolidone, the dispersion stability of the color material is good. This effect is remarkable particularly when the standard boiling point of 1-(2-hydroxyethyl)-2-pyrrolidone is higher than that of the polyhydric alcohol.

The ink jet recording method includes discharging the above-described aqueous ink jet ink composition from a recording head to adhere the composition to a recording medium.

According to this ink jet recording method, curling of the recording medium is unlikely to occur after recording.

The ink jet recording apparatus includes:

the above-described aqueous ink jet ink composition,

an ink container containing the aqueous ink jet ink composition, and

a recording head discharging the aqueous ink jet ink composition, wherein

the ink container has an openable and closable ink inlet for loading the aqueous ink jet ink composition.

According to this ink jet recording apparatus, since a user can refill an aqueous ink jet ink composition due to the presence of the ink inlet, there is no need to, for example, replace the container, and the convenience is good. In addition, even if the ink inlet is opened to cause a state in which the solvent of the aqueous ink jet ink composition is likely to volatilize, good dispersion stability of the color material of the aqueous ink jet ink composition is likely to be maintained.

What is claimed is:

1. An aqueous ink jet ink composition comprising:
a color material, water, a polyhydric alcohol having a standard boiling point of 270.0° C. or more, and 1-(2-hydroxyethyl)-2-pyrrolidone, wherein
a mass ratio of the content of the polyhydric alcohol to that of 1-(2-hydroxyethyl)-2-pyrrolidone is 3.1 or more and 7.0 or less.

2. The aqueous ink jet ink composition according to claim 1, wherein
a content of the polyhydric alcohol is 5.0 mass % or more and 20.0 mass % or less based on the total amount of the aqueous ink jet ink composition.

3. The aqueous ink jet ink composition according to claim 1, wherein
the polyhydric alcohol has a standard boiling point of less than 304° C.

4. The aqueous ink jet ink composition according to claim 1, wherein
the color material is a pigment.

5. The aqueous ink jet ink composition according to claim 1, wherein
the aqueous ink jet ink composition is loaded in a recording apparatus that includes an openable and closable ink inlet and an ink storage unit for storing the injected ink.

6. An ink jet recording method comprising:
discharging the aqueous ink jet ink composition according to claim 1 from a recording head to adhere the composition to a recording medium.

7. An ink jet recording apparatus comprising:
the aqueous ink jet ink composition according to claim 1;
an ink container for accommodating the aqueous ink jet ink composition; and
a recording head for discharging the aqueous ink jet ink composition, wherein
the ink container has an openable and closable ink inlet for loading the aqueous ink jet ink composition.
